(19) United States
(12) Patent Application Publication
(10) Pub. No.: US 2007/0218381 A1
(43) Pub. Date: Sep. 20, 2007

(54) TONER, METHOD FOR PRODUCING THE TONER AND IMAGE FORMING APPARATUS

(76) Inventors: Osamu Uchinokura, Mishima-shi (JP); Naohiro Watanabe, Sunto-gun (JP); Junichi Awamura, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/685,969

(22) Filed: Mar. 14, 2007

(30) Foreign Application Priority Data
Mar. 15, 2006 (JP) 2006-070106
Jan. 11, 2007 (JP) 2007-002948

(51) Int. Cl. G03G 9/087

(52) U.S. Cl. 430/108.1; 430/109.4; 430/110.1; 430/137.1

(57) ABSTRACT

It is an object to provide toner excellent in charge stability, fixing property at low temperature, durability, microdot reproducibility and cleaning ability. An excellent image forming apparatus using the toner is provided. Said toner has at least a plurality of resins, a colorant and a layered inorganic material in which at least a part of ions in the layered inorganic material has been exchanged with organic ions in the toner prepared by dispersing and/or emulsifying an oil phase comprising at least a toner composition and/or a toner composition precursor in a water-based medium to granulate, and wherein a first resin in said a plurality of resins has a weight average molecular weight of 3,000 to 10,000 in a molecular weight distribution obtained by gel permeation chromatography (GPC).

### BACKGROUND OF THE INVENTION

1. Field of the Invention

The present invention relates to a toner used for a developer for developing an electrostatic charge image in electrographs, electrostatic recordings and electrostatic printings, and an image forming apparatus using the toner. More particularly, the present invention relates to toner and an image forming apparatus used in copy machines, laser printers and plain paper facsimiles using a direct or indirect electrograph development system.

2. Description of the Related Art

In order to control electrical charge of the toner, many charge controlling agents have been added. However, in a method for producing the toner by melting and kneading one in which a colorant and if necessary additives have been added to a thermoplastic resin as a binding resin and subsequently pulverizing and classifying, a so-called pulverization method, the charge controlling agent can not stand still in long use because there is a limitation to reduce a particle diameter and it is severe to make high quality images, structure silicate for highly agglutinative substance salts easily becomes uneven due to difficult procedure for making high dispersion and is easily dissociated from the toner in a development step to which high shear is given, charge reduction is caused by spent to a carrier in a two-component development and filming to a developing roller is caused in a one-component development (see Japanese Patent Application Laid-Open (JP-A) No. 2005-49858).

It is impossible to control the arrangement of materials in each particle because the pulverization is performed after kneading. When the amount of the charge controlling agent is increased for enhancing a charge property, the filming and side effects on a fixing property occur.

Meanwhile, methods for producing the toner using a polymerization method or an emulsification dispersion method have been known. As the polymerization method, a suspension polymerization method in which a monomer, a polymerization initiator, a colorant and a charge controlling agent are added to a water-based medium containing a dispersant with stirring to form oil drops and subsequently the polymerization is performed is known. An association method in which particles obtained using an emulsification polymerization or a dispersion polymerization are aggregated and fusion-bonded is also known.

However, in such methods, although the particle diameter of the toner can be reduced, a major ingredient of the binding resin is limited to a polymer obtained by a radical polymerization. Thus, it is not possible to produce the toner using a polyester resin or an epoxy resin suitable for color toner as the major ingredient of the binding resin.

Thus, the method for producing the toner using the emulsification dispersion method in which a mixture of the binding resin and the colorant is mixed with the water-based medium to emulsify is known (see JP-A No. 05-66600 and JP-A No. 08-211655). This can address to the reduction of the toner particle diameter and additionally expands a selection range of the binding resin.

The method for producing the toner by emulsifying and dispersing the polyester resin and then aggregating and fusion bonding the resulting particles is known (see JP-A No. 10-020552 and JP-A No. 11-007156). This can suppress the occurrence of fine particles and reduce emulsification loss.

However, the toner obtained using the polymerization method or the emulsification dispersion method tends to become spherical due to interface intension of liquid drops produced in a dispersion step. Thus, when a blade cleaning is used, the spherical toner rotates and moves into the space between a cleaning blade and a photoconductor, which disturbs the cleaning.

Thus, the method of making the particle amorphous by stirring at high speed before the completion of the polymerization to give a mechanical force to the particle is known (see JP-A No. 62-266550). However, when such a method is used, a dispersion state becomes unstable, and the particles are easily integrated one another.

Also, the method of obtaining association particles having particle diameters of 5 μm to 25 μm by aggregating the particles using polyvinyl alcohol having a particular saponification degree as the dispersant is known (see JP-A No. 2005-49858). However, the association particle obtained in this way has a problem in that the particle diameter easily becomes large, and has the unstable charge property.

In relation to exchanged layered inorganic material, JP-A No. 2003-515795, JP-A No. 2006-500605, JP-A No. 2006-503313 and JP-A No. 2003-202708 are known.

### BRIEF SUMMARY OF THE INVENTION

In recent toner development, a hot offset resistance performance as well as a fixable temperature range are assured with assuring a fixing performance at low temperature and storage resistance by mixing multiple types of binding resin components. However, even when multiple types of resins having different thermal properties are used, these resins are evenly dispersed or compatible in the toner to offset a potential of each resin. That is, a lower limit of the fixing performance at low temperature is sometimes sacrificed or an upper limit temperature of hot offset property is sometimes sacrificed. An inherence of such a tendency has been a problem upon guarantee of a robust property in the fixing performance assuring the broad fixing temperature range with accomplishing the fixing at low temperature in a higher order.

The present invention aims at accomplishing the fixing performance and other performances of the toner without sacrificing the potential of each resin in the toner using multiple different resins.

And the present invention aims at (1) balancing a charge stability and the fixing property at low temperature, (2) providing the toner excellent in durability, (3) providing the toner and the image forming apparatus capable of obtaining high grade images excellent in fine dot reproducibility, (4) providing the toner whose cleaning ability is good and (5) providing the toner and the image forming apparatus capable of accomplishing the problems (1) to (4) simultaneously.

As a result of an extensive study to solve the problems described above, the present inventors have completed the following invention.

[1] A toner, comprising:

a plurality of resins,

a colorant, and

a layered inorganic material,

wherein a first resin in the plurality of resins has a weight average molecular weight of 3,000 to 10,000 in a molecular weight distribution determined by gel permeation chromatography (GPC); the layered inorganic material is a layered inorganic material in which at least a part of ions have been exchanged with organic ions; and the toner is granulated by dispersing and/or emulsifying an oil phase containing at least any one of a toner composition and a toner composition precursor in a water-based medium.

[2] The toner according to [1] above, wherein the organic ion is an organic cation.

[3] The toner according to [1] above, wherein the first resin is a resin having a polyester skeleton.

[4] The toner according to [3] above, wherein the resin having the polyester skeleton is a polyester resin.

[5] The toner according to [4] above, wherein the polyester resin is an unmodified polyester resin.

[6] The toner according to [1] above, wherein the first resin has no fraction which is insoluble in tetrahydrofuran (THF).

[7] The toner according to [1] above, wherein a second resin in the a plurality of resins has the weight average molecular weight Mw2 which is larger than the weight average molecular weight Mw1 of the first resin.

[8] The toner according to [7] above, wherein Mw2/Mw1≧1.5.

[9] The toner according to [7] above, wherein the second resin comprises a crosslinking type resin.

[10] The toner according to [9] above, wherein the crosslinking type resin is formed from a modified polyester resin.

[11] The toner according to [9] above, wherein the crosslinking type resin is formed from modified polyester having a site capable of reacting with an active hydrogen group and a compound having the active hydrogen group.

[12] The toner according to [1] above, wherein the oil phase is formed by separately preparing a first oil phase comprising at least the first resin and a second oil phase comprising the precursor which becomes at least the second resin, comprising the exchanged layered inorganic material in one of the first or second oil phases and mixing them.

[13] The toner according to [12] above, wherein the oil phase comprising the exchanged layered inorganic material is the first oil phase.

[14] The toner according to [1] above, wherein a weight ratio of the exchanged layered inorganic material relative to the toner composition and/or the toner composition precursor is 0.05% by weight to 2.0% by weight.

[15] The toner according to [1] above, wherein in a distribution of the exchanged layered inorganic material in the toner, its existence amount in a region up to 5 μm from a toner surface is larger than an existence amount of a composition ratio of the combined toner.

[16] The toner according to [1] above, wherein a weight ratio of the second resin to the first resin in the a plurality of resins is 5/95 to 30/70.

[17] The toner according to [1] above, wherein in the oil phase, at least the toner composition and/or the toner composition precursor has been dissolved or dispersed in the solvent.

[18] The toner according to [17] above, wherein the solvent contains an organic solvent and wherein the organic solvent is removed upon granulation.

[19] The toner according to [1] above, wherein an average circularity of the toner is 0.930 to 0.970.

[20] The toner according to [1] above, wherein a volume average particle diameter of the toner is 3 μm to 8 μm, and wherein a ratio of the volume average particle diameter to a number average particle diameter is 1.00 or more and 1.25 or less.

[21] The toner according to [1] above, wherein particles having the particle diameter of 2 μm or less in the toner is 1% by number to 10% by number.

[22] The toner according to [1] above, wherein a glass transition point of the toner is 40° C. to 70° C.

[23] The toner according to [1] above, wherein the water-based medium contains a polymer dispersant.

[24] The toner according to [23] above, wherein the polymer dispersant is a water soluble polymer.

[25] A developer which develops a latent electrostatic image formed on a latent image bearing member, wherein the developer is a two-component developer composed of toner and a magnetic carrier, and wherein the toner has at least a plurality of resins, a colorant and a layered inorganic material in which at least a part of ions in the layered inorganic material has been exchanged with organic ions in the toner prepared by dispersing and/or emulsifying an oil phase comprising at least a toner composition and/or a toner composition precursor in a water-based medium to granulate, and wherein a first resin in the a plurality of resins has a weight average molecular weight of 3,000 to 10,000 in a molecular weight distribution obtained by gel permeation chromatography (GPC).

[26] A developer which is a one-component developer which develops a latent electrostatic image formed on a latent image bearing member, wherein the toner has at least a plurality of resins, a colorant and a layered inorganic material in which at least a part of ions in the layered inorganic material has been exchanged with organic ions in the toner prepared by dispersing and/or emulsifying an oil phase comprising at least a toner composition and/or a toner composition precursor in a water-based medium to granulate, and wherein a first resin in the a plurality of resins has a weight average molecular weight of 3,000 to 10,000 in a molecular weight distribution obtained by gel permeation chromatography (GPC).

[27] A method for producing toner prepared by dispersing and/or emulsifying an oil phase comprising at least a toner composition and/or a toner composition precursor in a water-based medium to granulate, wherein the oil phase contains at least a first resin, a precursor of a second resin or the second resin and a layered inorganic material in which at least a part of ions in the layered inorganic material has been exchanged with organic ions, and wherein the toner has at least a plurality of resins, a colorant and the layered inorganic material in which at least a part of ions in the layered inorganic material has been exchanged with organic ions, and wherein the first resin has a weight average molecular weight of 3,000 to 10,000 in a molecular weight distribution obtained by gel permeation chromatography (GPC).

[28] An image forming apparatus comprising at least an image bearing member bearing a latent image, a charging apparatus having a charging member which evenly charges an image bearing member surface, an exposing apparatus which writes a latent electrostatic image on the surface of the charged image bearing member, a developing apparatus which visualizes the latent electrostatic image formed on the image bearing member surface with toner on a developer bearing member, a transferring apparatus which transfers a toner image visualized on the image bearing member onto a recording medium directly or through an intermediate transfer body, and a fixing apparatus which fixes the toner image on the recording medium with heat and/or pressure, wherein the image forming apparatus uses the toner according to [1].

[29] A vessel with toner, wherein the toner has at least a plurality of resins, a colorant and a layered inorganic material in which at least a part of ions in the layered inorganic material has been exchanged with organic ions in the toner prepared by dispersing and/or emulsifying an oil phase comprising at least a toner composition and/or a toner composition precursor in a water-based medium to granulate, and wherein a first resin in the a plurality of resins has a weight average molecular weight of 3,000 to 10,000 in a molecular weight distribution obtained by gel permeation chromatography (GPC).

[30] A process cartridge having a developing unit having a developer and an image bearing member, wherein the developer is a two-component developer composed of toner and a magnetic carrier, and wherein the toner has at least a plurality of resins, a colorant and a layered inorganic material in which at least a part of ions in the layered inorganic material has been exchanged with organic ions in the toner prepared by dispersing and/or emulsifying an oil phase comprising at least a toner composition and/or a toner composition precursor in a water-based medium to granulate, and wherein a first resin in the a plurality of resins has a weight average molecular weight of 3,000 to 10,000 in a molecular weight distribution obtained by gel permeation chromatography (GPC).

[31] A process cartridge having a developing unit having a developer and an image bearing member, wherein the developer is a one-component developer, and wherein the toner has at least a plurality of resins, a colorant and a layered inorganic material in which at least a part of ions in the layered inorganic material has been exchanged with organic ions in the toner prepared by dispersing and/or emulsifying an oil phase comprising at least a toner composition and/or a toner composition precursor in a water-based medium to granulate, and wherein a first resin in the a plurality of resins has a weight average molecular weight of 3,000 to 10,000 in a molecular weight distribution obtained by gel permeation chromatography (GPC).

According to the present invention, the toner excellent in charge stability, fixing property at low temperature, durability, fine dot reproducibility and cleaning ability is obtained. Although being speculated, it is believed that the excellent toner is obtained by having the following natures.

When the multiple types of resins are compatible one another in the toner, there is a tendency to lose the resin property (thermal property and physical property) which each toner alone has. For example, in the case of the toner using crystalline polyester, originally it is aimed to exploit a sharp melt property which is the nature derived from the crystallinity of crystalline polyester. However, when the toner having crystalline polyester is combined with the other resin, it has been known that the sharp melt property which is an original effect is inhibited by coexistence of the other resin with crystalline polyester in compatible state.

In the case of the present invention, the toner has at least a plurality of resins, the colorant and the layered inorganic material in which at least a part of ions in the layered inorganic material has been exchanged with organic ions in the toner prepared by dispersing and/or emulsifying the oil phase comprising at least the toner composition and/or the toner composition precursor in a water-based medium to granulate, and the first resin in the a plurality of resins has the weight average molecular weight of 3,000 to 10,000 in the molecular weight distribution obtained by gel permeation chromatography (GPC). Therefore, it is thought that potentials of respective resins can be elicited by forming a pseudo-incompatible state between different resins (it is speculated that molecular chains composing the resins are not present in uniformly compatible state between the resins, visually finely dispersed but domains in which each resin is finely dispersed are mutually present, and each resin each independently present as if a marble pattern.) and the fixing performance can be accomplished in higher order.

In particular, it is thought that a mixed body of one resin with the exchanged layered inorganic material and the other resin form the pseudo-incompatible state described above to bring about the effects of the present invention.

According to the present invention, it is possible to provide the toner excellent in charge stability, fixing property at low temperature, durability, fine dot reproducibility and cleaning ability, and also provide the excellent image forming apparatus using the toner.

### BRIEF DESCRIPTION OF THE SEVERAL VIEWS OF THE DRAWINGS

FIG. 1 shows one example of an image forming apparatus used in the present invention;

FIG. 2 shows another example of an image forming apparatus used in the present invention;

FIG. 3 shows another example of an image forming apparatus used in the present invention;

FIG. 4 shows another example of an image forming apparatus used in the present invention; and

FIG. 5 shows an example of a chart for cleaning ability evaluation used in the present invention.

### DETAILED DESCRIPTION OF THE INVENTION

Since the present invention is the toner prepared by dispersing and/or emulsifying in an oil water phase to granulate, it is possible to disperse in a liquid. Thus, for the resin, it becomes possible to perform the sufficient dispersion without cutting the binding resin upon dispersion as well as it is possible to untangle the aggregates of the exchanged layered inorganic material which is remarkably aggregated. The layered inorganic material untangles its aggregate by exchange treatment with the organic cation, and thus it becomes possible to disperse sufficiently. This stabilizes the charge property and sufficiently suppresses the spent and the filming. For two types of the resins, one resin alone can be dispersed as well as the layered inorganic material serves effectively to form the state in which the two types of the resins are difficult to be in compatible state. Thus it becomes possible that characteristics of the two types of resins are exploited sufficiently, and it becomes possible to balance the fixing property at low temperature and the hot offset property.

The exchanged layered inorganic material is hydrophobic but has an appropriate hydrophilicity, and thus, is easily oriented to a water phase side in the oil drops upon dispersion/emulsification, i.e., it is shifted to the surface side in the liquid drops and is present on the toner surface. Thus, it is possible to have the charge property of the same performance as that obtained by pulverization by a smaller amount, and this can also solve a defect to the fixing property.

It is possible to reduce the particle size and accomplish a shape alteration. Thus, the toner excellent in cleaning ability can be made.

In the present invention, in the oil phase comprising at least the toner composition and/or the toner composition precursor, it is preferable that at least the toner composition and/or the toner composition precursor is dissolved or dispersed in the solvent. The solvent preferably contains the organic solvent. It is also preferable that the organic solvent is removed upon formation of toner base particles or after forming the toner base particles.

The organic solvent can be appropriately selected depending on the purpose, and preferably has a boiling point of lower than 150° C. because the removal thereof is easy. Specifically, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. Among them, toluene, xylene, benzene, methylene chloride, 1,2-dichloroethane, chloroform and carbon tetrachloride are preferable, and ethyl acetate is particularly preferable. These may be used alone or in combination of two or more.

The amount of the organic solvent to be used can be appropriately selected depending on the purpose, and is preferably 40 parts by weight to 300 parts by weight, more preferably 60 parts by weight to 140 parts by weight and still more preferably 80 to 120 parts by weight relative to 100 parts by weight of the toner composition and/or the toner composition precursor (hereinafter also referred to as a toner material).

In the present invention, it is important to use the exchanged layered inorganic material in which at least a part of the ions in the layered inorganic material has been exchanged with the organic ion. This organically exchanged layered inorganic material can easily alter the shape of the toner by using for the toner prepared by dispersing in the water-based medium to granulate. The layered inorganic material is highly hydrophilic due to its layer structure. Thus, when the layered inorganic material without being exchanged is used for the toner granulated by dispersing in the water-based medium, the layered inorganic material migrates in the water-based medium and can not alter the shape of the toner. The layered inorganic material has an appropriate hydrophobicity by exchanging at least a part of the ions in the layered inorganic material with the organic ion, and is present in the vicinity of the surface in the oil drops to make the shape alteration possible upon granulation by dispersing and/or emulsifying the oil phase comprising the toner composition and/or the toner composition precursor in the water-based medium. As the organic ion, the organic cation is preferable.

This organically exchanged layered inorganic material is good at charging performance, and can significantly exert the charge property even in a small amount.

A content of the organically exchanged layered inorganic material is preferably 0.05% by weight to 2.0% by weight relative to the amount of the toner composition and/or the toner composition precursor.

The organically exchanged layered inorganic material can be appropriately selected, and includes montmorillonite, bentonite, bentonite, hectorite, attapulgite, sepiolite and mixtures thereof. Among them, organically exchanged montmorillonite or bentonite is preferable because it does not affect toner properties, the viscosity can be easily controlled and an amount thereof to be added can be small.

Commecially available products of the layered inorganic material in which the part has been exchanged with the organic cation include quaternium 18 bentonite such as Bentone 3, Bentone 38, Bentone 38V (supplied from Rheox), Tixogel VP (supplied from United Catalyst), Clayton 34, Clayton 40, Clayton XL (supplied from Southern Clay); stearalconium bentonite such as Bentone 27 (supplied from Rheox), Tixogel LG (supplied from United Catalyst), Clayton AF, Clayton APA (supplied from Southern Clay); and quaternium 18/benzalkonium bentonite such as Clayton HT and Clayton PS (supplied from Southern Clay). Clayton AF and Clayton APA are particularly preferable.

It can be identified by surface observation by TEM, and XPS that these layered inorganic material is present in the vicinity of the surface of the toner

In XPS, concerning a particular element used for the layered inorganic material, when a surface atom density (A) obtained when the normal toner is measured and an atom density (B) of XPS for the toner once melted and kneaded is measured in the same way, it is proven to be A>B for the toner unevenly distributed near the surface. A surface region which can be observed by XPS is about 0.5 μm from the surface.

A specific surface area per unit mass can be enlarged by reducing a distribution diameter of the exchanged layered inorganic material, and the high performance can be elicited with a small amount. Therefore, the dispersion diameter of the exchanged layered inorganic material in the oil phase is preferably 0.01 μm to 0.6 μm.

In the present invention, the first resin can be appropriately selected depending on the purpose, polyester resins can be used, and the unmodified polyester resin is preferable. This can enhance the fixing property at low temperature and glossiness.

The unmodified polyester resin includes polycondensates of polyol and polycarboxylic acid.

It is necessary that the weight average molecular weight of the first resin is 3,000 to 10,000. When the weight average molecular weight is less than 3,000, the viscosity in the oil phase is remarkably reduced and the exchanged layered inorganic material is aggregated again when dispersed in the oil phase. Thus, although the exchanged layered inorganic material can be oriented in the vicinity of the surface, due to being aggregated, as is the case with the pulverized toner, spent defect in long durability occurs as well as the shape becomes spherical because the exchanged layered inorganic material is not oriented evenly in the vicinity of the surface.

When it exceeds 10,000, because of the high viscosity, mobility to the surface becomes low upon emulsification, the charge property can not be obtained sufficiently, and since it becomes difficult to unevenly distribute near the surface, the shape becomes spherical and the defect occurs in the cleaning ability.

Additionally, it is preferable that the first resin contains no fraction insoluble in tetrahydrofuran (THF). When the oil phase is formed upon granulation of the toner, it is possible to make the toner in the even dispersion of the first resin by containing no fraction insoluble in THF.

The glass transition temperature of the unmodified polyester resin is typically 30° C. to 70° C., more preferably 35° C. to 60° C. and still more preferably 35° C. to 55° C. When the glass transition temperature is lower than 30° C., the heat resistant storage stability is sometimes reduced. When it exceeds 70° C., the fixing property at low temperature is sometimes reduced.

A hydroxyl group value of the unmodified polyester resin is preferably 5 mg KOH/g or more, more preferably 10 mg KOH/g to 120 mg KOH/g and still more preferably 20 mg KOH/g to 80 mg KOH/g. When the hydroxyl group value is less than 5 mg KOH/g, the heat resistant storage stability and the fixing property at low temperature are hardly balanced sometimes.

An acid value of the unmodified polyester resin is preferably 1.0 mg KOH/g to 50.0 mg KOH/g, and more preferably 1.0 mg KOH/g to 30.0 mg KOH/g. This makes the toner be easily charged negatively.

The method for forming the toner base particles can be appropriately selected from publicly known methods. Specifically, the methods for forming the toner base particles using a suspension polymerization method or an emulsification polymerization aggregation method, and the method for forming the toner base particles with generating an adhesive substrate are included. Among them, the method for forming the toner base particles with generating the adhesive substrate is preferable. Here, the adhesive substrate is a substrate having an adhesiveness to the recording media such as papers.

The method for forming the toner base particles with generating the adhesive substrate is the method in which the toner material contains the compound having the active hydrogen group and the polymer having the reactivity to the active hydrogen group and the toner base particles are formed with generating the adhesive substrate by reacting the compound having the active hydrogen group with the polymer having the reactivity to the active hydrogen group in the water-based medium, and the generated adhesive substrate corresponds to the second resin. The adhesive substrate may further contain additional binding resins known publicly.

The toner obtained in this way preferably contains the colorant, and may further contain other ingredients such as releasing agents and charge controlling agents appropriately selected as needed.

The weight average molecular weight MW2 of the adhesive substrate which becomes the second resin is preferably 5,000 to 1,000,000 and particularly preferably 7,000 to 500,000. It is also preferable that the ratio of the weight average molecular weight MW2 of the second resin to the weight average molecular weight MW1 of the first resin is MW2/MW1≧1.5. When MW2 is less than 5,000, the compatibility of the first resin becomes high and no phase separation occurs. Thus, the potential of each resin is sacrificed and the hot offset resistance is sometimes reduced.

The glass transition temperature of the adhesive substrate which becomes the second resin is preferably 30° C. to 70° C. and more preferably 40° C. to 65° C. When the glass transition temperature is lower than 30° C., the heat resistant storage stability is sometimes deteriorated. When it exceeds 70° C., the fixing property at low temperature is not sometimes sufficiently. The toner containing the polyester resin to which a crosslinking reaction or an extending reaction has been given as the adhesive substrate has the good storage stability even though it has the low glass transition temperature.

The glass transition temperature can be measured using TG-DSC system TAS-100 (supplied from Rigaku Denki Co., Ltd.) as follows. First, about 10 mg of the toner is placed in a sample vessel made from aluminium, which is then placed on a holder unit and set in an electric furnace. DSC measurement was performed using a differential scanning calorimeter (DSC) by first heating from the room temperature up to 150° C. at a temperature rising speed of 10° C./minute, leaving stand at 150° C. for 10 minutes, then cooling to the room temperature and leaving stand for 10 minutes, heating again up to 150° C. at a temperature rising speed of 10° C./minute under nitrogen atmosphere. The glass transition temperature can be calculated from a tangent of an endothermic curve in the vicinity of the glass transition temperature and a contact point with a base line using the analysis system in TAS-100 system.

The adhesive substrate which becomes the second resin is appropriately selected depending on the purpose, and polyester based resins are suitably used.

The polyester based resin is appropriately selected depending on the purpose, and urea-modified polyester based resins are suitably used.

The urea-modified polyester based resin is obtained by reacting amines as the compound having the active hydrogen group with a polyester prepolymer having an isocyanate group as the polymer having the site capable of reacting with the active hydrogen group in the water-based medium. When the urea-modified polyester based resin is synthesized, an urethane bond may be formed by adding alcohols in addition to amines. A molar ratio of the urethane bond to an urea bond generated in this way (for distinguishing from the urethane bond which the polyester prepolymer having the isocyanate bond has) is preferably 0 to 9, more preferably 1/4 to 4 and particularly preferably 2/3 to 7/3. When this ratio is larger than 9, the hot offset resistance is sometimes reduced.

The compound having the active hydrogen group acts as an extending agent or a crosslinking agent when the polymer having the site capable of reacting with the active hydrogen group performs an extending reaction or a crosslinking reaction in the water-based medium.

Specific examples of the active hydrogen group include hydroxyl groups (alcoholic hydroxyl groups and phenolic hydroxyl groups), amino groups, carboxyl groups and mercapto groups. The active hydrogen group may be alone or the mixture of two or more.

The compound having the active hydrogen group can be appropriately selected depending on the purpose, and amines are suitable because they can be made to have the high molecular weight by the extending reaction or the crosslinking reaction with the polyester prepolymer when the polymer having the site capable of reacting with the active hydrogen group is the polyester prepolymer having the isocyanate group.

Amines can be appropriately selected depending on the purpose, and specifically includes diamine, trivalent or more amine, amino alcohol, amino mercaptan, amino acids and amino acids having blocked amino groups. The mixture of diamine and trivalent or more amine in a small amount is preferable. These may be used alone or in combination of two or more.

Diamine includes aromatic diamine, alicyclic diamine and aliphatic diamine. Specific examples of aromatic diamine include phenylenediamine, diethyltoluenediamine and 4,4′-diaminodiphenylmethane. Specific examples of alicyclic diamine include 4,4′-diamino-3,3′-dimethyldichlorohexylmethane, diaminocyclohexane and isophoroneamine. Specific examples of aliphatic diamine include ethylenediamine, tetramethylenediamine and hexamethylenediamine. Specific examples of trivalent or more amine include diethylenetriamine, and triethylenetetraamine. Specific examples of amino alcohol include ethanolamine and hydroxyethylaniline. Specific examples of amino mercaptan include aminoethylmercaptan and aminopropylmercaptan. Specific examples of amino acids include aminopropionic acid and aminocaproic acid. Specific examples of those having the blocked amino group include ketimine compounds and oxazolidine compounds obtained by blocking the amino group with ketones such as acetone, methyl ethyl ketone and methyl isobutyl ketone.

To terminate the extending reaction or the crosslinking reaction of the compound having the active hydrogen group with the polymer having the site capable of reacting with the active hydrogen group, a reaction terminator can be used. By the use of the reaction terminator, it is possible to control the molecular weight of the adhesive substrate in the desired range. Specific examples of the reaction terminator include monoamine such as diethylamine, dibutylamine, butylamine and laurylamine and ketimine compounds obtained by blocking the amino group thereof.

The ratio of an equivalent of the isocyanate group in the polyester prepolymer to an equivalent of the amino group in amines is preferably 1/3 to 3, more preferably 1/2 to 2 and particularly preferably 2/3 to 1.5. When this ratio is less than 1/3, the fixing property at low temperature is sometimes reduced. When it exceeds 3, the molecular weight of the urea-modified polyester based resin is decreased and the hot offset resistance is sometimes reduced.

The polymer (hereinafter sometimes referred to as the “prepolymer”) having the site capable of reacting with the active hydrogen group can be appropriately selected from publicly known resins, and includes polyol resins, polyacrylic resins, polyester resins, epoxy resins and derivatives thereof. Among them, it is preferable to use the polyester resin in terms of high fluidity upon melting and transparency. These may be used alone or in combination of two or more.

A functional group which the prepolymer has and which can react with the active hydrogen group includes isocyanate, epoxy, carboxyl groups, and functional groups represented by a chemical structural formula —COCl, and among them, the isocyanate group is preferable. The prepolymer may have one such a functional group or two or more.

As the prepolymer, it is preferable to use the polyester resin having the isocyanate group capable of generating the urea bond because the molecular weight of a polymer component is easily controlled, oilless fixing property at low temperature can be assured, and in particular, the good releasing property and fixing property can be assured when there is no releasing oil application mechanism to a heating medium for fixing.

The polyester prepolymer containing the isocyanate group can be appropriately selected depending on the purpose. Specifically, a reaction product of the polyester resin having the active hydrogen group obtained by polycondensation of polyol and polycarboxylic acid with polyisocyanate is included.

Polyol can be appropriately selected depending on the purpose, and diol, trivalent or more alcohol and mixtures of diol and trivalent or more alcohol can be used. The mixture of diol and trivalent alcohol in a small amount is preferable. These may be used alone or in combination of two or more.

Specific examples of diol include alkylene glycol such as ethylene glycol, 1,2-propylene glycol, 1,3-propylene glycol, 1,4-butanediol and 1,6-hexanadiol; diol having oxyalkylene such as diethylene glycol, triethylene glycol, dipropylene glycol, polyethylene glycol, polypropylene glycol and tetramethylene glycol; alicyclic diol such as 1,4-cyclohexanedimethanol and hydrogenated bisphenol A; those obtained by adding alkylene oxide such as ethylene oxide, propylene oxide and butylene oxide to alicyclic diol; bisphenols such as bisphenol A, bisphenol F and bisphenol S; and alkylene oxide adducts of bisphenols such as those obtained by adding alkylene oxide such as ethylene oxide, propylene oxide and butylene oxide to bisphenols. The carbon number of alkylene glycol is preferably 2 to 12. Among them, alkylene glycol having 2 to 12 carbon atoms and the alkylene oxide adducts of bisphenols are preferable. The alkylene oxide adducts of bisphenols or the mixture of the alkylene oxide adducts of bisphenols with alkylene glycol having 2 to 12 carbon atoms are particularly preferable.

As trivalent or more alcohol, it is possible to use trivalent or more aliphatic alcohol, trivalent or more polyphenols and alkylene oxide adducts of trivalent or more polyphenols. Specific example of trivalent or more aliphatic alcohol include glycerine, trimethylolethane, trimethylolpropane, pentaerythritol and sorbitol. Specific examples of trivalent or more polyphenols include trisphenol PA, phenolnovolac and cresolnovolac. Specific examples of the alkylene oxide adducts of trivalent or more polyphenols include those obtained by adding alkylene oxide such as ethylene oxide, propylene oxide and butylene oxide to trivalent or more polyphenols.

When using by mixing diol and trivalent or more alcohol, a weight ratio of trivalent or more alcohol to diol is preferably 0.01% to 10% and more preferably 0.01% to 1%.

Polycarboxylic acids can be appropriately selected depending on the purpose, and dicarboxylic acids, trivalent or more carboxylic acids and mixtures of the dicarboxylic acid and the trivalent or more carboxylic acid can be used. The mixture of the dicarboxylic acid and the trivalent or more carboxylic acid in a small amount is preferable. These may be used alone or in combination of two or more.

Specific examples of dicarboxylic acids include bivalent alkanoic acids, bivalent alkenoic acids and aromatic dicarboxylic acids. Specific examples of bivalent alkanoic acid include succinic acid, adipic acid and sebacic acid. Bivalent alkenoic acid has preferably 4 to 20 carbon atoms, and specifically includes maleic acid and fumaric acid. Aromatic dicarboxylic acid has preferably 8 to 20 carbon atoms, and specifically includes phthalic acid, isophthalic acid, terephthalic acid and naphthalene dicarboxylic acid. Among them, the bivalent alkenoic acid having 2 to 20 carbon atoms and the aromatic dicarboxylic acid having 8 to 20 carbon atoms are preferable.

As trivalent or more carboxylic acids, trivalent or more aromatic carboxylic acids can be used. The trivalent or more aromatic carboxylic acid has preferably 9 to 20 carbon atoms, and specifically includes trimellitic acid and pyromellitic acid.

As polycarboxylic acids, it is also possible to use acid anhydrate or lower alkyl ester of any of dicarboxylic acids, trivalent or more carboxylic acid and the mixture of dicarboxylic acid and trivalent or more carboxylic acid. Specific examples of lower alkyl ester include methyl ester, ethyl ester and isopropyl ester.

When using by mixing dicarboxylic acid and trivalent or more carboxylic acid, the weight ratio of trivalent or more carboxylic acid to dicarboxylic acid is preferably 0.01% to 10% and more preferably 0.01% to 1%.

For a mixed ratio when polyol and polycarboxylic acid are polycondensed, an equivalent ratio of hydroxyl group in polyol to carboxyl group in polycarboxylic acid is preferably 1 to 2 typically, more preferably 1 to 1.5 and still more preferably 1.02 to 1.3.

A content of a structural unit derived from polyol in the polyester prepolymer having the isocyanate group is preferably 0.5% by weight to 40% by weight, more preferably 1% by weight to 30% by weight and particularly preferably 2% by weight to 20% by weight. When this content is less than 0.5% by weight, the hot offset resistance is sometimes reduced, and it becomes difficult to balance the heat resistant storage stability and the fixing property at low temperature of the toner. When it exceeds 40% by weight, the fixing property at low temperature is sometimes reduced.

Polyisocyanate can be appropriately selected depending on the purpose, and includes aliphatic diisocyanate, alicyclic diisocyanate, aromatic diisocyanate, aromatic aliphatic diisocyanate, isocyanurates and those obtained by blocking them with phenol derivatives, oxime or caprolactam.

Specific examples of aliphatic diisocyanate include tetramethylene diisocyanate, hexamethylene diisocyanate, methyl 2,6-diisocyanatocaproate, octamethylene diisocyanate, decamethylene diisocyanate, dodecamethylene diisocyanate, tetradecamethylene diisocyanate, trimethylhexane diisocyanate, and tetramethylhexane diisocyanate. Specific examples of alicyclic diisocyanate include isophorone diisocyanate, and cyclohexylmethane diisocyanate. Specific examples of aromatic diisocyanate include trilene diisocyanate, diisocyanatodiphenylmethane, 1,5-naphthylene diisocyanate, 4,4-diisocyanatodiphenyl, 4,4′-diisocyanato-3,3′-dimethylphenyl, 4,4′-diisocyanato-3-methyldiphenylmethane and 4,4′-diisocyanto-diphenyl ether. Specific examples of aromatic aliphatic diisocyanate include α,α,α′,α′-tetramethylxylylene diisocyanate. Specific examples of isocyanurates include tris(isocyanatoalkyl) isocyanurate and tris(isocyanatocycloalkyl) isocyanurate. These may be used alone or in combination of two or more.

When polyisocyanate is reacted with the polyester resin having the hydroxyl group, the equivalent ratio of the isocyanate group in polyisocyanate to the hydroxyl group in the polyester resin is preferably 1 to 5 typically, more preferably 1.2 to 4 and particularly preferably 1.5 to 3. When the equivalent ratio exceeds 5, the fixing property at low temperature is sometimes reduced. When it is less than 1, the offset resistance is sometimes reduced.

The content of the structural unit derived from polyisocyanate in the polyester prepolymer having the isocyanate group is preferably 0.5% by weight to 40% by weight, more preferably 1% by weight to 30% by weight and still more preferably 2% by weight to 20% by weight. When this content is less than 5% by weight, the hot offset resistance is sometimes reduced. When it exceeds 40% by weight, the fixing property at low temperature is sometimes reduced.

An average number of the isocyanate groups which the polyester prepolymer has per molecule is preferably one or more, more preferably 1.2 to 5 and still more preferably 1.5 to 4. When this average number is less than 1, the molecular weight of the urea-modified polyester based resin is decreased and the hot offset resistance is sometimes reduced.

The weight average molecular weight of the polymer having the site capable of reacting with the active hydrogen group is preferably 1,000 to 30,000 and more preferably 1,500 to 15,000. When the weight average molecular weight is less than 1,000, the heat resistance storage stability is sometimes reduced. When it exceeds 30,000, the fixing property at low temperature is sometimes reduced. The weight average molecular weight can be obtained by measuring the fraction soluble in tetrahydrofuran using gel permeation chromatography (GPC).

Specific example of the adhesive substrate include a mixture of one obtained by ureating with isophoronediamine a polyester prepolymer obtained by reacting a polycondensate of a bisphenol A ethylene oxide 2 mol adduct and isophthalic acid to isophorone diisocyanate, with the polycondensate of the bisphenol A ethylene oxide 2 mol adduct and isophthalic acid; a mixture one obtained by ureating with isophoronediamine a polyester prepolymer obtained by reacting a polycondensate of a bisphenol A ethylene oxide 2 mol adduct and isophthalic acid to isophorone diisocyanate, with the polycondensate of the bisphenol A ethylene oxide 2 mol adduct and terephthalic acid; a mixture one obtained by ureating with isophoronediamine a polyester prepolymer obtained by reacting a polycondensate of a bisphenol A ethylene oxide 2 mol adduct/bisphenol A propylene oxide 2 mol adduct and terephthalic acid to isophorone diisocyanate, with the polycondensate of the bisphenol A ethylene oxide 2 mol adduct/bisphenol A propylene oxide 2 mol adduct and terephthalic acid; a mixture one obtained by ureating with isophoronediamine a polyester prepolymer obtained by reacting a polycondensate of a bisphenol A ethylene oxide 2 mol adduct/bisphenol A propylene oxide 2 mol adduct and terephthalic acid to isophorone diisocyanate, with the polycondensate of the bisphenol A propylene oxide 2 mol adduct and terephthalic acid; a mixture one obtained by ureating with hexamethylenediamine a polyester prepolymer obtained by reacting a polycondensate of a bisphenol A ethylene oxide 2 mol adduct and terephthalic acid to isophorone diisocyanate, with the polycondensate of the bisphenol A ethylene oxide 2 mol adduct and terephthalic acid; a mixture one obtained by ureating with hexamethylenediamine a polyester prepolymer obtained by reacting a polycondensate of a bisphenol A ethylene oxide 2 mol adduct and terephthalic acid to isophorone diisocyanate, with the polycondensate of the bisphenol A ethylene oxide 2 mol adduct/bisphenol A propylene oxide 2 mol adduct and terephthalic acid; a mixture one obtained by ureating with ethylenediamine a polyester prepolymer obtained by reacting a polycondensate of a bisphenol A ethylene oxide 2 mol adduct and terephthalic acid to isophorone diisocyanate, with the polycondensate of the bisphenol A ethylene oxide 2 mol adduct and terephthalic acid; a mixture one obtained by ureating with hexamethylenediamine a polyester prepolymer obtained by reacting a polycondensate of a bisphenol A ethylene oxide 2 mol adduct and isophthalic acid to diphenylmethane diisocyanate, with the polycondensate of the bisphenol A ethylene oxide 2 mol adduct and isophthalic acid; a mixture one obtained by ureating with hexamethylenediamine a polyester prepolymer obtained by reacting a polycondensate of a bisphenol A ethylene oxide 2 mol adduct/bisphenol A propylene oxide 2 mol adduct and terephthalic acid/dodecenyl succinic acid anhydrate to diphenylmethane diisocyanate, with the polycondensate of the bisphenol A ethylene oxide 2 mol adduct/bisphenol A propylene oxide 2 mol adduct and terephthalic acid; and a mixture one obtained by ureating with hexamethylenediamine a polyester prepolymer obtained by reacting a polycondensate of a bisphenol A ethylene oxide 2 mol adduct and isophthalic acid to toluene diisocyanate, with the polycondensate of the bisphenol A ethylene oxide 2 mol adduct and isophthalic acid.

It is desirable that the measurement of the molecular weight in the present invention is performed as follows.

When the molecular weight can be measured in the first resin alone and the second resin alone, the measurement is performed as follows. GPC can be performed as follows. First, a column is stabilized in a heat chamber at 40° C. At this temperature, tetrahydrofuran is run at a flow rate of 1 mL/minute as a column solvent, and 50 μL to 200 μL of a tetrahydrofuran solution containing a sample adjusted at a concentration of 0.05% by weight to 0.6% by weight is injected to measure. The THF sample solution is filtrated through a filter of 0.45 μm for liquid chromatography to remove the fraction insoluble in THF before the injection. Upon measurement of the molecular weight, the value is calculated from the relation of logarithmic values of a standard curve made from several standard samples with counted numbers. As the standard samples for making the standard curve, monodispersion polystyrene having molecular weights of 6×10², 2.1×10², 4×10², 1.75×10⁴, 1.1×10⁵, 3.9×10⁵, 8.6×10⁵, 2×10⁶ and 4.48×10⁶ (supplied from Pressure Chemical or Toyo Soda Kogyo Co., Ltd.) can be used. At that time, it is desirable to use about 10 standard samples. As a detector, a refractive index detector can be used.

The presence or absence of the fraction insoluble in THF in the binder resin is determined when the THF sample solution for measuring a molecular weight distribution is made. That is, a filter unit of 0.45 μm is attached to a tip of a syringe and the solution is pushed out from the syringe. When there is no clog on the filter, it is determined that there is no fraction insoluble in THF.

To specify the molecular weight of the first resin in the toner, the molecular weight is identified by the following measurement.
(Separate quantification of the first resin from other resins) High performance liquid chromatography (HPLC) measurement apparatus (supplied from GL Science)
Column: Inertsil ODS-3V (5 m, 1504.6 mm I.D.) (supplied from Tosoh Corporation and GL Science)
Detector: differential refraction index (RI), fluorescence (FL), diode array detector
Temperature: 35° C.
Solvent: chloroform
Flow rate: 1.0 mL/minute
Sample: inject 0.4 mL of 0.15% sample
Pretreatment of sample: The toner is dissolved in chloroform (Wako Pure Chemical Industries Inc.) at 0.15% by weight and filtrated through the filter of 0.2 μm to use the filtrate as the sample. Then, 100 μL of the chloroform sample solution is injected to measure. The first resin in the sample has a maximum peak detected by the detector. When those showing the maximum peaks in three detectors are different, the first resin can be measured by separately collecting and quantifying. The column and the solvent can be appropriately selected in the solubility of the resin. When separately collected, it is preferable in terms of reducing a frequency of the separated collection to make a column diameter and length long.

When it has been found that the second resin is a crosslinked resin, a melted component may be extracted by performing Soxhlet extraction in THF for 4 hours.

These components are measured using the above GPC to quantify the molecular weight.

When the second resin is the crosslinked resin, the case in which there is the fraction insoluble in THF, even when the molecular weight of the resin contained in the melted component is measured, the weight average molecular weight of the second resin can not correctly measured is also thought. In this case, the weight average molecular weight of the second resin can be regarded to be larger than the weight average molecular weight of the resin contained in the THF melted component. Therefore, when the weight average molecular weight measured using the THF melted component of the second resin is larger than the weight average molecular weight of the first resin, the weight average molecular weight of the second resin can be regarded to be larger than the weight average molecular weight of the first resin.

The weight ratio of the second resin to the first resin is preferably 5/95 to 30/70 and more preferably 10/90 to 30/70. When the weight ratio is less than 5/95, the hot offset resistance is sometimes reduced. When it exceeds 30/70, the fixing property at low temperature and the glossiness of the image are sometimes reduced.

The colorant can be appropriately selected from publicly known dyes and pigments depending on the purpose. For example, carbon black, nigrosine dyes, iron black, naphthol yellow S, hanza yellow (10G, 5G, G), cadmium yellow, yellow iron oxide, yellow ocher, chrome yellow, titanium yellow, polyazo yellow, oil yellow, hanza yellow (GR, A, RN, R), pigment yellow L, benzidine yellow (G, GR), permanent yellow (NCG), Balkan fast yellow (5G, R), tartrazine lake, quinoline yellow lake, anthrazane yellow BGL, isoindolinone yellow, colcothar, red lead, lead vermillion, cadmium red, cadmium mercury red, antimony vermillion, permanent red 4R, parared, faicer red, parachloroorthonitroaniline red, lithol fast scarlet G, brilliant fast scarlet, brilliant carmine BS, permanent red (F2R, F4R, FRL, FRLL, F4RH), fast scarlet VD, Balkan fast rubine B, brilliant scarlet G, lithol rubine GX, permanent red F5R, brilliant carmine 6B, pigment scarlet 3B, Bordeaux 5B, toluidine maroon, permanent Bordeaux F2K, helio Bordeaux BL, Bordeaux 10B, bon maroon light, bon maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, non-metallic phthalocyanine blue, phthalocyanine blue, fast sky blue, indanthrene blue (RS, BC), indigo, ultramarine blue, Prussian blue, anthraquinone blue, fast violet B, methyl violet lake, cobalt violet, manganese violet, dioxane violet, anthraquinone violet, chrome green, zinc green, chromium oxide, pyridian, emerald green, pigment green B, naphthol green B, green gold, acid green lake, malachite green, phthalocyanine green, anthraquinone green, titanium oxide, zinc flower, lithopone and mixtures thereof are included. The colorants which can be particularly suitably used include pigment red such as PR122, PR269, PR184, PR57:1, PR238, PR146 and PR185, pigment yellow such as PY93, PY128, PY155, PY180 and PY74, and pigment blue such as PB15:3. These may be used alone or in combination of two or more.

The colorant may be used by dispersing with the binding resin in the solvent or may be used as a dispersion of the colorant obtained by dispersing the colorant in the solvent. When the colorant is dispersed, the viscosity may be adjusted by partially adding the binding resin in order to add an appropriate shearing force.

A dispersed particle diameter of the colorant is preferably 1 μm or less. When the toner produced using the colorant having the dispersed particle diameter of more than 1 μm is used, the image quality is sometimes reduced, and in particular, a light transmittance state of OHR is easily reduced.

The dispersed particle diameter of the colorant can be measured using a particle size measurement apparatus Microtrack ultrafine particle size distribution meter UPA-EX150 (supplied from Nikkiso) using a laser Doppler method.

The content of the colorant in the toner can be appropriately selected depending on the purpose, and is typically 1% by weight to 15% by weight and preferably 3% by weight to 10% by weight. When the content of the colorant is less than 1% by weight, a coloring power of the toner is reduced. When it exceeds 15% by weight, the uneven dispersion of the pigment occurs in the toner, sometimes resulting in the reduction of the coloring power and the reduction of the electric property.

In the present invention, it is preferable that the water-based medium contains a macromolecular dispersant. The macromolecular dispersant is preferably a water soluble macromolecule. The water soluble macromolecule can be appropriately selected from those known publicly, and includes sodium carboxymethylcellulose, hydroxyethylcellulose and polyvinyl alcohol. These may be used alone or in combination of two or more.

When the oil phase comprising at least the toner composition and/or the toner composition precursor is emulsified and/or dispersed in the water-based medium, it is preferable to disperse the oil phase in the water-based medium with stirring.

Dispersing machines known publicly can be appropriately used for the dispersion. Specific examples of the dispersing machines include a low speed shearing dispersing machine, a high pressure jet dispersing machine and an ultrasonic dispersing machine. Among them, the high speed shearing dispersing machine is preferable because it can control the particle diameter of the dispersion body (oil drops) to 2 μm to 20 μm. When the high speed shearing dispersing machine is used, a rotation frequency, a dispersion time period and a dispersion temperature can be appropriately selected. The rotation frequency is preferably 1,000 rpm and 30,000 rpm and more preferably 5,000 to 20,000 rpm. The dispersion time period is preferably 0.1 minutes to 5 minutes in the case of a batch system. The dispersion temperature is preferably 0° C. to 150° C. and more preferably 40° C. to 98° C. under pressure. In general, when the dispersion temperature is higher, the dispersion is easier.

In the present invention, the toner can contain the releasing agent, the charge controlling agent, the resin particles, inorganic particles, fluidity enhancers, cleaning property enhancers, magnetic materials and metal soaps.

The releasing agent can be appropriately selected from those known publicly depending on the purpose, and wax having the carbonyl group, polyolefin waxes, and the wax which can use long chain hydrocarbon and have the carbonyl group are preferable. These may be used alone and in combination of two or more.

Specific examples of waxes having the carbonyl group include a carnauba wax, a montan wax, ester having multiple alkanoic acid residues such as trimethylolpropane tribehenate, pentaerythritol tetrabehenate, pentaerythritol diacetate dibehenate, glycerine tribehenate and 1,18-octadecandiol distearate; ester having multiple alkanol residues such as tristearyl trimellitate and distearyl maleate; amide having multiple alkanoic acid residues such as dibehenylamide; amide having multiple monoamine residues such as tristearylamide trimellitate; and dialkyl ketone such as distearyl ketone. Ester having multiple alkanoic acid residues is particularly preferable. Specific examples of polyolefin wax include polyethylene wax and polypropylene wax. Specific example of long chain hydrocarbon include paraffin wax and Sasol wax.

The melting point of the releasing agent is preferably 40° C. to 160° C., more preferably 50° C. to 120° C. and particularly preferably 60° C. to 90° C. When the melting point is lower than 40° C., the wax sometimes harmfully affects the heat resistant storage stability. When it exceeds 160° C., cold offset sometimes occurs upon fixing at low temperature.

A melting viscosity of the releasing agent is preferably 5 cps to 1,000 cps and more preferably 10 cps and 100 cps at a temperature which is 20° C. higher than the melting point of the releasing agent. When the melting viscosity is less than 5 cps, the releasing property is sometimes reduced. When it exceeds 1,000 cps, effects to enhance the hot offset resistance and the fixing property at low temperature are not sometimes obtained.

The content of the releasing agent in the toner is preferably 0% by weight to 40% by weight and more preferably 3% by weight to 30% by weight. When the content exceeds 40% by weight, the fluidity of the toner is sometimes reduced.

The toner of the present invention may contain a charge controlling agent if necessary in addition to the layered inorganic material. The charge controlling agents known publicly can be used, and include, for example, nigrosine dyes, triphenylmethane dyes, chromium-containing metal complex dyes, molybdic acid chelate pigments, rhodamine-based dyes, alkoxy-based amine, quaternary ammonium salts (including fluorine modified quaternary ammonium salts), alkylamide, a single body or compounds of phosphorus, a single body or compounds of tungsten, fluorine-based active agents, salicylate metal salts and metal salts of salicylic acid derivatives. Specifically, Bontron 03 of the nigrosine dye, Bontron P-51 of the quaternary ammonium salt, Bontron S-34 of the metal-containing azo dye, E-82 of oxynaphthoic acid-based metal complex, E-84 of salicylic acid-based metal complexes, E-89 of phenol-based condensate (supplied from Orient Chemical Industries Ltd.); TP-302 and TP-415 of a quaternary ammonium salt molybdenum complexes (supplied from Hodogaya Chemical Co., Ltd.); Copy Charge PSY VP2038 of the quaternary ammonium salts, Copy Blue PR of the triphenylmethane derivative, Copy Charge NEG VP2036 and Copy Charge NX VP434 of the quaternary ammonium salts (supplied from Hoechst); LRA-901, LA-147 which is a boron complex (supplied from Japan Carlit Co., Ltd.) copper phthalocyanine, perylene, quinacridone, azo-based pigments, and polymer-based compounds having functional groups such as sulfonic acid group, carboxyl group and quaternary ammonium salt are included. In the present invention, the amount of the charge controlling agent to be used is determined depending on the type of the binder resin, the presence or absence of the additive added if necessary and the methods for producing the toner including the dispersion method, and is not primarily limited, but the charge controlling agent is used in the range of 0.1 parts by weight to 5 parts by weight relative to 100 parts by weight of the binder resin. The range of 0.2 parts by weight to 2 parts by weight is preferable. When it exceeds 5 parts by weight, the charge property of the toner is too large, the effect of the major charge controlling agent is reduced, and an electrostatic sucking force with the developing roller is increased, resulting in the reduction of fluidity of the developer and the reduction of the image density. These charge controlling agent and releasing agent can also be melted and kneaded together with the master batch and the resin, and of course may be added into the organic solvent upon dissolution or dispersion.

The resin particle is not particularly limited as long as it is the resin capable of forming an aqueous dispersion in the water-based medium, can be appropriately selected from the publicly known resins, and may be a thermoplastic resin or a thermosetting resin. Specifically, vinyl resins, polyurethane resins, epoxy resins, polyester resins, polyamide resins, polyimide resins, silicon resins, phenol resins, melamine resins, urea resins, aniline resins, ionomer resins and polycarbonate resins are included. Among them, it is preferable to be one or more resins selected from the group consisting of vinyl resins, polyurethane resins, epoxy resins and polyester resins because it is easy to obtain the aqueous dispersion of finely spherical resin particles. These may be used alone or in combination of two or more.

The vinyl resin is obtained by homopolymerizing or copolymerizing a vinyl monomer, and specifically includes styrene-(meth)acrylate ester copolymers, styrene-butadiene copolymers, (meth)acrylic acid-acrylate ester copolymers, styrene-acrylonitrile copolymers, styrene-maleic acid anhydrate copolymers and styrene-(meth)acrylic acid copolymers.

As the resin particle, it is also possible to use the copolymer obtained by polymerizing a monomer having multiple unsaturated groups. The monomer having multiple unsaturated groups can be appropriately selected depending on the purpose, and specifically includes a sodium salt of methacrylic acid ethylene oxide adduct sulfate ester Eleminol RS-30 (supplied from Sanyo Chemical Industries, Ltd.), divinyl benzene and 6-hexanediol diacrylate.

The resin particle can be obtained by polymerizing using the publicly known method, and it is preferable to use as the aqueous dispersion of the resin particles. The methods for preparing the aqueous dispersion of the resin particles include the method for producing the aqueous dispersion of the resin particles by polymerizing the vinyl monomer using the suspension polymerization, the emulsification polymerization, the seed polymerization or the dispersion polymerization method in the case of the vinyl resin; the method for producing the aqueous dispersion of the resin particles by dispersing a precursor of a monomer or an oligomer or a solution thereof in the water-based medium in the presence of an appropriate dispersant followed by heating or adding a curing agent to cure in the case of polyaddition or condensation resins of polyester resins, polyurethane resins and epoxy resins; the method in which an appropriate emulsifier is dissolved in the precursor of the monomer or the oligomer or the solution thereof and subsequently water is added to perform phase inversion emulsification; the method in which the resin particles are obtained by pulverizing and classifying using a mechanically rotary or jet fine pulverizer and then dispersed in water in the presence of the appropriate dispersant; the method in which the resin particles are obtained by spraying the resin solution and then dispersed in water in the presence of the appropriate dispersant; the method in which the resin particles are precipitated by adding a poor solvent to the resin solution or cooling the resin solution heated and melted in the solvent, and the resin particles are obtained by removing the solvent and then dispersed in water in the presence of the appropriate dispersant; the method in which the resin solution is dispersed in the water-based medium n the presence of the appropriate dispersant, and subsequently the solvent is removed by heating or pressurizing; and the method in which the appropriate emulsifier is dissolved in the resin solution and subsequently the water is added to perform the phase inversion emulsification.

Inorganic particles can be appropriately selected from those known publicly depending on the purpose, and specifically include silica, alumina, titanium oxide, barium titanate, magnesium titanate, calcium titanate, strontium titanate, zinc oxide, tin oxide, quartz sand, clay, mica, sand-lime stone, diatom earth, chromium oxide, cerium oxide, colcothar, antimony trioxide, magnesium oxide, zirconium oxide, barium sulfate, barium carbonate, calcium carbonate, silicon carbide, and silicon nitride. These may be used alone or in combination of two or more.

A primary particle diameter of the inorganic particle is preferably 5 nm to 2 μm and more preferably 5 nm to 500 nm. It is preferable that a specific surface area by BET method of the inorganic particle is 20 m²/g to 500 m²/g.

The content of the inorganic particle in the toner is preferably 0.01% by weight to 5.0% by weight and more preferably 0.01% by weight to 5.0% by weight.

When the surface treatment is given using a fluidity enhancer, the hydrophobicity of the toner surface is enhanced, and it is possible to suppress the reduction of the fluidity property and the charge property even under a high humidity environment. Specific examples of the fluidity enhancer include silane coupling agents, silylation agents, silane coupling agents containing alkyl fluoride group, organic titanate based coupling agents, aluminium based coupling agents, silicone oils and modified silicone oils.

When a cleaning ability enhancer is added to the toner, it becomes easy to remove the developer left on the photoconductor and a primary transfer medium after the development. Specific examples of the cleaning ability enhancer include zinc stearate, calcium stearate, metal salts of fatty acids such as stearic acid, methyl polymethacrylate particles and resin particles such as polystyrene particles obtained by soap-free emulsification polymerization. In the resin particles, it is preferable that the particle size distribution is narrow and the volume average particle diameter is 0.01 μm to 1 μm.

Magnetic materials can be appropriately selected from those known publicly depending on the purpose, and include iron powders, magnetite and ferrite. Among them, the white magnetic material is preferable in terms of color tone.

As one example of the methods for producing the toner, the method for forming the toner base particle with generating the adhesive substrate will be shown below. In such a method, the preparation of a water-based medium phase, the preparation of the oil phase containing the toner materials, the emulsification or dispersion of the toner materials, the generation of the adhesive substrate, the removal of the solvent, the synthesis of the polymer having the site capable of reacting with the active hydrogen group and the synthesis of the compound having the active hydrogen group are performed.

The water-based medium can be prepared by dispersing the resin particles in the water-based medium. The amount of the resin particle to be added in the water-based medium is preferably 0.5% by weight to 10% by weight.

The oil phase containing the toner materials can be prepared by dissolving or dispersing the toner materials, i.e., the compound having the active hydrogen group, the polymer having the site capable of reacting with the active hydrogen group, the organically exchanged layered inorganic material, the colorant, the releasing agent, the charge controlling agent and the unmodified polyester resin in the solvent.

At that time, it is preferable to obtain the oil phase by separately preparing a first oil phase having at least a first resin (unmodified polyester resin) and the organically exchanged layered inorganic material and a second oil phase having at least a second resin precursor (the polymer having the site capable of reacting with the active hydrogen group), and mixing them. By the use of the oil phase made by separately preparing the first oil phase and the second oil phase and mixing them, mixing and compatibility of the a plurality of resins are suppressed and the a plurality of resins are present in the pseudo-incompatible state in the toner to be able to assure the fixing performance at low temperature of the toner.

The first oil phase is prepared by highly dispersing the organically exchanged layered inorganic material and the first resin whose molecular weight is limited to be capable of migrating in the oil phase in the first oil phase. This enables the first oil phase component to migrate in particles before desolvent without completely mixing and being compatible of the first oil phase and the second oil phase in the dispersion mixed with the second oil phase. It is speculated that this can result in producing a surface layer side where the first oil phase component is rich in the toner particle together with the organically exchanged layered inorganic material easily shifted to an aqueous phase side (surface layer side). It is thought that these produce the effects of the present invention.

Among the toner materials, the components other than the polymer having the site capable of reacting with the active hydrogen group may be added and mixed in the water-based medium when the resin particles are dispersed in the water-based medium, or may be added in the water-based medium when the oil phase containing the toner materials is added to the water-based medium.

The toner materials can be emulsified or dispersed by dispersing the oil phase containing the toner materials in the water-based medium. And, the adhesive substrate which becomes the second resin is generated by reacting the compound having the active hydrogen group with the polymer having the site capable of reacting with the active hydrogen group in an extending and/or crosslinking reaction when the toner materials are emulsified or dispersed.

The adhesive substrate such as urea-modified polyester based resins may be generated by emulsifying or dispersing the oil phase containing the polymer having the site capable of reacting with the active hydrogen group, such as polyester prepolymer having isocyanate group, together with the compound having the active hydrogen group such as amine in the water-based medium, and then performing the extending and/or crosslinking reaction of both in the water-based medium; or may be generated by emulsifying or dispersing the oil phase containing the toner materials in the water-based medium in which the compound having the active hydrogen group has been previously added, and then performing the extending and/or crosslinking reaction of both in the water-based medium; or may be generated by emulsifying or dispersing the oil phase containing the toner materials in the water-based medium, subsequently adding the compound having the active hydrogen group, and then performing the extending and/or crosslinking reaction of both from particle interfaces in the water-based medium. In the case of performing the extending and/or crosslinking reaction of both from particle interfaces, the urea-modified polyester resin is preferentially formed on the surface of the produced toner, and a density gradient of the urea-modified polyester resin can also be provided in the toner.

A reaction condition to generate the adhesive substrate can be appropriately selected depending on the combination of the polymer having the site capable of reacting with the active hydrogen group with the compound having the active hydrogen. A reaction time period is preferably 10 minutes to 40 hours and more preferably 2 hours to 24 hours. A reaction temperature is preferably 0° C. to 150° C. and more preferably 40° C. to 98° C.

The method of stably forming the dispersion containing the polymer capable of reacting with the hydrogen group such as polyester prepolymer having the isocyanate group in the water-based medium includes the method in which the oil phase prepared by dissolving or dispersing the toner materials, i.e., the polymer having the reactivity to the active hydrogen group, the colorant, the organically exchanged layered inorganic material, the releasing agent, the charge controlling agent and the unmodified polyester resin in the solvent is added into the water-based medium and dispersed with a shearing force.

The dispersion can be performed using a dispersing machine known publicly, and the dispersing machine includes a low speed shearing dispersing machine, a high speed shearing dispersing machine, a frictional dispersing machine, a high pressure jet dispersing machine and an ultrasonic dispersing machine. The high speed shearing dispersing machine is preferable because it is possible to control the particle diameter of a dispersed body to 2 μm to 20 μm.

In the case of using the high speed shearing dispersing machine, the conditions such as rotation frequency, dispersion time period and dispersion temperature can be appropriately selected depending on the purpose. The rotation frequency is preferably 1,000 rpm to 30,000 rpm and more preferably 5,000 rpm to 20,000 rpm. The dispersion time period is preferably one minute to 5 minutes in the batch system, and the dispersion temperature is preferably 0° C. to 150° C. and more preferably 40° C. to 98° C. under pressure. When the dispersion temperature is higher, the dispersion is generally easier.

The amount of the water-based medium to be used when the toner materials are emulsified or dispersed is preferably 50 parts by weight to 2,000 parts by weight, and more preferably 100 parts by weight to 1,000 parts by weight relative to 100 parts by weight of the toner materials. When this amount to be used is less than 50 parts by weight, the dispersion state of the toner is deteriorated and the toner base particle having the given particle diameter is not sometimes obtained. When it exceeds 2,000 parts by weight, the production cost sometimes becomes high.

In the step of emulsifying or dispersing the oil phase containing the toner materials, it is preferable to use the dispersant from viewpoints that the dispersed body such as oil drops is stabilized, the desired shape is made and the particle size distribution is made sharp.

The dispersant can be appropriately selected depending on the purpose, and includes surfactants, dispersants of water hardly soluble inorganic compounds and polymer based protection colloid, and the surfactant is preferable. These may be used alone or in combination of two or more.

The surfactants include anion surfactants, cation surfactants, nonionic surfactants and ampholytic surfactants.

The anionic surfactants include alkyl benzene sulfonate salts, α-olefin sulfonate salts and phosphate ester, and those having fluoroalkyl group are suitably used. The anionic surfactants having fluoroalkyl group include fluoroalkyl carboxylic acids having 2 to 10 carbon atoms and metal salts thereof, perfluorooctanesulfonyl disodium glutamate, 3-[omega-fluoroalkyl(C6 to C11)oxy]-1-alkyl(C3 to C4) sodium sulfonate, 3-[omega-fluoroalkanoyl(C6 to C8)-N-ethylamino]-1-propane sodium sulfonate, fluoroalkyl (C11to C20) carboxylic acids and metal salts thereof, perfluoroalkyl carboxylic acids (C7 to C13) and metal salts thereof, perfluoroalkyl (C4 to C12) sulfonic acids and metal salts thereof, perfluorooctane sulfonic acid diethanol amide, N-propyl-N-(2-hydroxyethyl)perfluoroactanesulfoneamide, perfluoroalkyl(C6 to C10)sulfoneamidepropyltrimethyl ammonium salts, perfluoroalkyl(C6 to C10)-N-ethylsulfonyl glycine salts and monoperfluoroalkyl(C6 to C16)ethyl phosphate esters. Commercially available products of the anion surfactant having the fluoroalkyl group include Surflon S-111, S-112, S-113 (supplied from Asahi Glass Co., Ltd.), Fullard FC-93, FC-95, FC-98, FC-129 (supplied from Sumitomo 3M Ltd.), Unidain DS-101, DS-102 (supplied from Daikin Industries, Ltd.), Megafac F-110, F-120, F-113, F-191, F-812, F-833 (supplied from Dainippon Ink And Chemicals, Incorporated), F-Top EF-102, 103, 104, 105, 112, 123A, 123B, 306A, 501, 201, 204 (supplied from Tohchem Products Co., Ltd.), Ftergent F-100, F-150 (supplied from Neos Corporation).

The cation surfactants include amine salt type surfactants such as alkylamine salts, amino alcohol fatty acid derivatives, polyamine fatty acid derivatives and imidazoline; and quaternary ammonium salt type surfactants such as alkyltrimethyl ammonium salts, dialkyldimethyl ammonium salts, alkyldimethylbenzyl ammonium salts, pyridinium salts, alkylisoquinolinium salts and benzethonium chloride. Among them, aliphatic primary, secondary or tertiary amine acids having the fluoroalkyl group, aliphatic quaternary ammonium salts such as perfluoroalkyl(C6 to C10)sulfonamide propyltrimethyl ammonium salts, benzalkonium salts, benzethonium chloride, pyridinium salts and imidazolium salts are included. As commercially available products of the cation surfactants, it is preferable to use Surflon S-121 (supplied from Asahi Glass Co., Ltd.), Fullard FC-135 (supplied from Sumitomo 3M Ltd.), Unidain DS-202 (supplied from Daikin Industries, Ltd.), Megafac F-150, F-824 (supplied from Dainippon Ink And Chemicals, Incorporated), F-Top EF-132 (supplied from Tohchem Products Co., Ltd.) and Ftergent F-300 (supplied from Neos Corporation).

The nonionic surfactants include fatty acid amide derivatives and polyvalent alcohol derivatives.

Specific examples of the ampholytic surfactant include alanine, dodecyldi(aminoethyl)glycine, di(octylaminoethyl)glycine and N-alkyl-N,N-dimethyl ammonium betaine.

Specific examples of the water hardly soluble inorganic compound dispersant include tricalcium phosphate, calcium carbonate, titanium oxide, colloidal silica and hydroxyapatite.

The polymer based protection colloid includes homopolymers or copolymers obtained by polymerizing a monomer having carboxyl group, alkyl (meth)acrylate having hydroxyl group, vinyl ether, vinyl carboxylate, amide monomer, a monomer of acid chloride and a monomer having a nitrogen atom or a heterocyclic ring, polyoxyethylene based resins and celluloses. The above homopolymers or copolymers obtained by polymerizing the monomers include those having the constitution unit derived from vinyl alcohol.

Specific examples of the monomers having the carboxylic group include acrylic acid, methacrylic acid, α-cyanoacrylic acid, α-cyanomethacrylic acid, itaconic acid, crotonic acid, fumaric acid, maleic acid and maleic acid anhydride. Specific examples of (meth)acryl based monomer having the hydroxyl group include β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerine monoacrylate and glycerine monomethacrylate. Specific examples of vinyl ether include vinyl methyl ether, vinyl ethyl ether and vinyl propyl ether. Specific examples of vinyl carboxylate include vinyl acetate, vinyl propionate and vinyl butyrate. Specific examples of the amide monomer include acrylamide, methacrylamide, diacetone acrylamide, N-methylol acrylamide and N-methylol methacrylamide. Specific examples of acid chloride include acrylic acid chloride and methacrylic acid chloride. Specific examples of the monomer having the nitrogen atom or the heterocyclic ring include vinyl pyridine, vinyl pyrrolidone, vinyl imidazole and ethyleneimine. Specific examples of the polyoxyethylene based resin include polyoxyethylene, polyoxyethylene alkylamine, polyoxypropylene alkylamine, polyoxyethylene alkylamide, polyoxypropylene alkylamide, polyoxyethylene nonylphenyl ether, polyoxyethylene laurylphenyl ether, polyoxyethylene stearic acid phenyl and polyoxyethylene pelargonic acid phenyl. Specific examples of cellulose include methylcellulose, hydroxyethylcellulose and hydroxypropylcellulose.

Specific examples of the dispersant include those such as calcium phosphate which can be soluble in acid and alkali. When calcium phosphate is used as the dispersant, the calcium phosphate salt can be removed using the method of dissolving the calcium salt with hydrochloric acid and followed by washing with water or the method of decomposing by an enzyme.

A catalyst can be used for the extending and or crosslinking reaction when the adhesive substrate is generated. Specific examples of the catalyst include dibutyl tin laurate and dioctyl tin laurate.

The method of removing the organic solvent from the dispersion such as emulsified slurry includes the method in which the temperature in the entire reaction system is gradually raised to evaporate the organic solvent in the oil drops and the method in which the organic solvent is removed in the oil drops by spraying the dispersion into a dried atmosphere.

When the organic solvent is removed, the toner base particles are formed. The toner base particles can be washed and dried, and further classified. Classification may be performed in the solution by removing a fine particle portion using cyclone, decanter and centrifuge, or the classification may be performed after drying.

The resulting toner base particles may be mixed with the particles of the colorant, the releasing agent and the charge controlling agent. At that time, by applying a mechanical impact force, it is possible to inhibit the dissociation of the particles of the releasing agent from the surface of the toner base particles.

The method of applying the impact force includes the method of applying the impact force to the mixture using blades which rotate at high speed and the method of placing the mixture in high speed gas flow and crashing the particles one another or the particle to an appropriate crash plate by accelerating. An apparatus used for this method includes Ang Mill (supplied from Hosokawa Micron Ltd.), an apparatus in which a pulverization air pressure has been reduced by remodeling I type mill (supplied from Nippon Pneumatic MFG. Co., Ltd.), a hybridization system (Nara Machinery Co., Ltd.), a cryptron system (supplied from Kawasaki Heavy Industries, Ltd.) and an automatic mortar.

The toner of the present invention is produced using the method for producing the toner of the present invention.

The toner of the present invention is excellent in various properties such as transfer property and charge property and can form the image with high quality because its surface is smooth. When the toner of the present invention contains the adhesive substrate obtained by reacting the compound having the active hydrogen with the polymer having the site capable of reacting with the active hydrogen group in the water-based medium, the toner is more excellent in various properties such as transfer property and fixing property. Thus, the toner of the present invention can be used in various fields and can be suitably used for the image formation by electrographic methods.

The volume average particle diameter of the toner of the present invention is preferably 3 μm to 8 μm and more preferably 4 μm to 7 μm. When the volume average particle diameter is less than 3 μm, the toner is fusion-bonded on the surface of the carrier in long term stirring in the developing apparatus and the charging capacity of the carrier is sometimes reduced in the case of the two-component developer. In the case of the one-component developer, the filming of the toner to the developing roller and the fusion-bond of the toner to the member such as blade which makes the toner a thin layer occur sometimes. When the volume average particle diameter exceeds 8 μm, it becomes difficult to obtain the image with high resolution and high quality, and variation of the toner particle diameters becomes sometimes large when the toner is consumed and supplied in the developer.

The ratio of the volume average particle diameter to the number average particle diameter of the toner of the present invention is preferably 1.00 to 1.25 and more preferably 1.05 to 1.25. This reduces the variation of the toner particle diameters in the developer even when the toner is consumed and supplied over time and gives the good and stable developing property in the long term stirring in the developing apparatus in the case of the two-component developer. In the case of the one-component developer, even when the toner is consumed and supplied, the variation of the toner particle diameters is reduced as well as the filming of the toner to the developing roller and the fusion-bond of the toner to the member such as blade which makes the toner a thin layer are suppressed. The good and stable image is given in the long term use (stirring) in the developing apparatus. Thus the image with high quality can be obtained. When this ratio exceeds 1.25, it becomes difficult to obtain the image with high resolution and high quality, and variation of the toner particle diameters becomes sometimes large when the toner is consumed and supplied in the developer.

The rate of the particles having the particle diameter of 2 μm or less which are fine particles of the toner is preferably 1% by number to 10% by number. When it exceeds 10% by number, the filming of the toner to the developing roller and the fusion-bond of the toner to the blade occur, and it becomes difficult to obtain the image with high resolution in the long term use of the developing apparatus.

The volume average particle diameter and the ratio of the volume average particle diameter to the number average particle diameter can be measured as follows using a particle size measurement equipment Multisizer III (supplied from Beckman Coulter). First, 0.1 mL to 5 mL of the surfactant such as alkylbenzene sulfonate salt as the dispersant is added to 100 mL to 150 mL of an aqueous solution of an electrolyte such as an aqueous solution of about 1% by weight sodium chloride. Subsequently, about 2 mg to 20 mg of a sample to be measured is added thereto. A dispersion treatment for about one minute to 3 minutes is given to the aqueous solution of the electrolyte using an ultrasonic dispersing machine. Then the volume and the number of the toner are measured using 100 μm aperture to calculate a volume distribution and a number distribution. The volume average particle diameter and the number average particle diameter of the toner can be calculated from the resulting distributions.

An average circularity of the toner of the present invention is preferably 0.930 to 0.970 and more preferably 0.945 to 0.965. The circularity is a value obtained by dividing a circumference length of a circle which has an area equal to a projected area of a sample by a circumference length of the sample. The content of the particles having the circularity of less than 0.930 is preferably 15% or less in the toner. When the average circularity is less than 0.930, the satisfactory transfer property and the image with high quality and no dust are not sometimes obtained. When it exceeds 0.970, cleaning defect occurs on the photoconductor and the transfer belt in the image forming apparatus employing the blade cleaning, and stain on the image possibly occurs. For example, when the image such as photo image having a high image area rate is formed, the toner which has formed a non-transfer image due to paper supply defect is accumulated on the photoconductor to cause scumming of the image or stain the charge roller which contacts with and charges the photoconductor. Thus, the original charging performance is not sometimes exerted.

The average circularity and the rate % by number of the toner particles having the particle diameter of 2 μm or less can be measured by passing a suspension containing the toner through a taking a picture detecting zone, detecting an particle image optically by CCD camera and analyzing by optical detecting zone techniques, and can be measured using a flow type particle image analyzer FPIA+2100 (supplied from Sysmex).

A shape coefficient SF1 of the toner of the present invention is preferably 115 or more and 130 or less. SF1 is defined by the formula:
SF1=π(L/2)2/A×100,
wherein L is an average value of the maximum length of the toner and A is an average value of the projected area of the toner. SF1 in a true sphere is 100. As the value of SF1 becomes larger than 100, the shape becomes from a spherical shape to an amorphous shape. L and A can be obtained by randomly sampling 100 carrier images magnified to 300 times using S-800 of FE-SEM (supplied from Hitachi Ltd.) and analyzing using an image analyzer Luzex AP (supplied from Nireco Corporation) through an interface.

A specific surface area of the toner of the present invention is preferably 0.5 m²/g to 3.0 m²/g and more preferably 0.5 m²/g to 2.5 m²/g. When the specific surface area is less than 0.5 m²/g, no effect of an externally adding agent added to the toner is obtained, and the fluidity and the charge property are sometimes deteriorated. When it exceeds 3.0 m²/g, the transfer property is sometimes deteriorated. The specific surface area can be measured using BET method. Specifically, the specific surface area can be measured by absorbing nitrogen gas onto the surface of the sample using a specific surface area measurement apparatus, Traister 3000 (supplied from Shimadzu Corporation) and using BET multipoint method.

A penetration of the toner of the present invention is preferably 15 mm or more and more preferably 20 mm to 30 mm. When the penetration is less than 15 mm, the heat resistant storage stability is sometimes deteriorated. The penetration can be measured by a penetration test (JIS K2235-1991). Specifically, the toner is filled in a 50 mL glass vessel, left stand in an incubator at 50° C. for 20 hours, then cooled to room temperature, and the penetration test is performed. The larger the value of the penetration is, the more excellent the heat resistant storage stability is.

In the toner of the present invention, it is preferable in terms of balancing the fixing property at low temperature and the offset resistance that a lower limit temperature for fixing is low and the temperature at which the offset does not occur is high. Therefor, it is preferable that the lower limit temperature for fixing is lower than 40° C. and the temperature at which the offset does not occur is 200° C. or above. Here, the lower limit temperature for the fixing is the lower limit of the fixing temperature when a copy test is performed using the image forming apparatus, the resulting image is rubbed with a pat, and then a residual rate of the image density is 70% or more. The temperature at which the offset does not occur can be obtained by measuring the temperature at which the offset does not occur using the image forming apparatus controlled to be developed with a given amount of the toner.

A thermal property of the toner is also referred to as a flow tester property, and is evaluated as a softening temperature, flow-out initiating temperature and ½ rule softening point. These thermal properties can be measured by appropriately selected methods, and can be measured using an elevated flow tester CFT500 model (supplied from Shimadzu Corporation).

The softening temperature of the toner of the present invention is preferably 30° C. or more and more preferably 50° C. to 90° C. When the softening temperature is lower than 30° C., the heat resistant storage stability is sometimes deteriorated.

The flow-out initiating temperature of the toner of the present invention is preferably 60° C. or above, and more preferably 80° C. to 120° C. When the flow-out initiating temperature is lower than 60° C., at least one of the heat resistant storage stability or the offset resistance is sometimes reduced.

The ½ rule softening temperature of the toner of the present invention is preferably 90° C. or above, and more preferably 100° C. to 170° C. When the ½ rule softening point is lower than 90° C., the offset resistance is sometimes deteriorated.

The glass transition temperature of the toner of the present invention is preferably 40° C. to 70° C., and more preferably 45° C. to 65° C. When the glass transition temperature is lower than 40° C., the heat resistant storage stability is sometimes deteriorated. When it exceeds 70° C., the fixing property at low temperature is sometimes insufficient. The glass transition temperature can be measured using a differential scanning calorimeter DSC-60 (supplied from Shimadzu Corporation).

A color of the toner of the present invention can be appropriately selected depending on the purpose, can be one or more selected from the group consisting of black toner, cyan toner, magenta toner and yellow toner, and each color toner can be obtained by appropriately selecting the colorant.

The developer of the present invention contains the toner of the present invention, and may further contain other components such as carrier selected appropriately. Thus, the image with high quality which is excellent in transfer property and charge property can be formed stably. The developer may be the one-component developer or the two-component developer, but the two-component developer is preferable in terms of enhanced durability when used for high speed printers corresponding to the enhancement of recent information processing speed.

In the case of using the developer of the present invention as the one-component developer, even when the toner is consumed and supplied, the variation of the toner particle diameters is small, and the filming of the toner to the developing roller and the fusion-bond of the toner to the blade which makes the toner the thin layer are reduced. The good and stable developing property and image are obtained even in the long term stirring in the developing apparatus.

In the case of using the developer of the present invention as the two-component developer, even when the toner is consumed and supplied, the variation of the toner particle diameters is small, and the good and stable developing property and image are obtained even in the long term stirring in the developing apparatus.

The carrier can be appropriately selected depending on the purpose, and one having a core material and a resin layer which covers the core material is preferable.

Materials for the core material can be appropriately selected from those known publicly, and include manganese-strontium based materials and manganese-magnesium based materials of 50 emu/g to 90 emu/g. To assure the image density, it is preferable to use a highly magnetic material such as iron powders of 100 emu/g or more and magnetite of 75 emu/g to 120 emu/g. It is also preferable to use a low magnetic material such as copper-zinc based materials of 30 emu/g to 80 emu/g because they can alleviate the impact of the developer in an ear-standing state against the photoconductor and they are advantageous for making the image high quality. These may be used alone or in combination of two or more.

The volume average particle diameter of the core material is preferably 10 μm to 150 μm and more preferably 40 μto 100 μm. When the volume average particle diameter is less than 10 μm, fine powders are increased in the carrier, and magnetization per particle is reduced to cause carrier scattering. When it exceeds 150 μm, the specific surface area is reduced to sometimes cause the toner scattering, and particularly reproducibility of solid portions is sometimes deteriorated in full color images in which solid portions are many.

Materials of the resin layer can be appropriately selected from publicly known resins depending on the purpose, and include amino based resins, polyvinyl based resins, polystyrene based resins, polyhalogenated olefin, polyester based resins, polycarbonate based resins, polyethylene, polyvinyl fluoride, polyvinylidene fluoride, polytrifluoroethylene, polyhexafluoropropylene, copolymers of vinylidene fluoride and acryl monomer, copolymers of vinylidene fluoride and vinyl fluoride, fluoroterpolymer such as copolymers of tetrafluoroethylene, vinylidene fluoride and a monomer having no fluoro group, and silicone resins. These may be used alone or in combination of two or more.

Specific examples of the amino based resins include urea-formaldehyde resins, melamine resins, benzoguanamine resins, urea resins, polyamide resins and epoxy resins. Specific examples of the polyvinyl based resins include acryl resins, methyl polymethacrylate, polyacrylonitrile, polyvinyl acetate, polyvinyl alcohol and polyvinyl butyral. Specific examples of the polystyrene based resins include polystyrene and styrene-acryl copolymers. Specific examples of the polyhalogenated olefin include polyvinyl chloride. Specific examples of the polyester based resins include polyethylene terephthalate and polybutylene terephthalate.

The resin layer may contain conductive powders if necessary. Specific examples of the conductive powder include metal powders, carbon black, titanium oxide, tin oxide and zinc oxide. The average particle diameter of the conductive powder is preferably 1 μm or less. When the average particle diameter is exceeds 1 μm, it sometimes becomes difficult to control electric resistance.

The resin layer can be formed by dissolving the silicone resin in the solvent to prepare a coating solution, subsequently applying the coating solution on the surface of the core material using a coating method publicly known, then drying and baking. As the coating method, a dip coating method, a spray method and a brush coating method can be used. The solvent can be appropriately selected depending on the purpose, and includes toluene, xylene, methyl ethyl ketone, methyl isobutyl ketone and butyl acetate cellsolves. The baking may be performed by an externally heating method or an internally heating method. The methods include methods using a fixed electric furnace, a fluidal electric furnace, a rotary electric furnace and a burner furnace, and methods using microwaves.

The content of the resin layer in the carrier is preferably 0.01% by weight to 5.0% by weight. When this content is less than 0.01% by weight, the uniform resin layer can not be sometimes formed on the surface of the core material. When it exceeds 5.0% by weight, the carriers are fusion-bonded one another because the resin layer is thick, and the uniformity of the carrier is sometimes reduced.

The content of the carrier in the two-component developer is preferably 90% by weight to 98% by weight, and more preferably 93% by weight to 97% by weight.

The developer of the present invention can be used for the image formation by various electrophotography known publicly such as magnetic one component development, non-magnetic one-component development and two-component development.

The vessel with toner of the present invention has the toner of the present invention. The vessel with toner of the present invention includes the case having the developer of the present invention.

The vessel with toner of the present invention can be appropriately selected from those known publicly, and those having a vessel main body and a cap are suitably used.

For the toner vessel main body, its size, shape, structure and material can be appropriately selected depending on the purpose. For example, as the shape, a cylindrical one is preferable, and the vessel in which spiral asperity is formed on an inside periphery and a part of or all of the spiral portion has an accordion function is preferable. The toner which is the content can be moved to a discharging side by rotating such a vessel main body.

The material of the vessel main body is preferably a material having good dimension accuracy, and includes polyester resins, resins of polyethylene, polypropylene, polystyrene, polyvinyl chloride, polyacrylic acid, polycarbonate, ABS resins and polyacetal resins.

The vessel with the toner of the present invention is easily stored and transported, is excellent in handling property, and can be suitably used for resupply of the toner by detachably attaching to the process cartridge and the image forming apparatus.

The process cartridge of the present invention has the developing unit having the developer of the present invention and the image bearing member, and may have other units appropriately selected if necessary. This can develop the latent electrostatic image borne on the image bearing member using the developer to form a visible image.

It is preferable that the developing unit has the vessel with the toner of the present invention and a developer bearing member which bears the developer to feed. The developing unit may further have a layer thickness regulatory member for regulating a layer thickness of the borne toner.

The process cartridge of the present invention can be provided detachably to the image forming apparatus main body.

The image forming method of the present invention forms the image using the developer of the present invention. Thus, the image with high quality is efficiently obtained.

The image forming method of the present invention preferably has a latent electrostatic image forming step, a developing step, a transferring step and a fixing step, and if necessary may further have an electricity removing step, a cleaning step, a recycling step and a controlling step.

The image forming apparatus which forms the image using the developer of the present invention preferably has the image bearing member, a latent image forming unit, the developing unit having the developer of the present invention, a transferring unit and a fixing unit, and if necessary may further have an electricity removing unit, a cleaning unit, a recycling unit and a controlling unit.

The latent electrostatic image forming step is a step of forming a latent electrostatic image on the image bearing member. The material, the structure and the size of the image bearing member can be appropriately selected from those known publicly. The materials include inorganic materials such as amorphous silicon and serene, and organic materials such as polysilane and phthalopolymethine, and amorphous silicon is preferable because of its long lifetime. The shape is preferably a drum shape. The latent electrostatic image can be formed by evenly charging the surface of the image bearing member and subsequently exposing like the image, and formed by the latent electrostatic image forming unit. It is preferable that the latent electrostatic image forming unit has a charging device which evenly charging the surface of the image bearing member and an exposing device which exposes the surface of the image bearing member.

The charging can be performed by applying voltage to the surface of the image bearing member using the charging device. The charging device can be appropriately selected depending on the purpose, and includes contact charging devices known publicly comprising a conductive or semi-conductive roll, brush, film and rubber blade, and non-contact charging device utilizing corona discharge, e.g., corotron and scorotron.

The exposure can be performed by exposing the surface of the image bearing member using the exposing device. The exposing device can be appropriately selected depending on the purpose, and various exposing devices, e.g., a copy optical system, a rod lens eye system, a laser optical system and a liquid crystal shutter optical system can be used. A light backside method of exposing from the backside of the image bearing member may be employed.

The developing step is a step of forming the visible image by developing the latent electrostatic image using the developer of the present invention. The visible image can be formed using the developing unit. The developing unit can be appropriately selected from those known publicly, and it is preferable to have a developing device which houses the developer of the present invention and can impart the developer to the latent electrostatic image in contact or in no contact with it. As the developing device, it is preferable to use the developing device comprising the vessel with the toner of the present invention. The developing device may employ a dry developing system or a wet developing system, or may be a monochromatic developing device or a multicolor developing device. Specifically, a stirring device which charges by frictionizing and stirring the developer and the developing device having a rotatable magnet roller are included. The developer to be housed in the developing device is the developer of the present invention, and may be the one-component developer or the two-component developer.

In the developing device having the two-component developer, the toner and the carrier are mixed and stirred, the toner is charged by friction at that time and kept in the ear-standing state on the surface of the rotating magnet roller to form a magnetic brush. The magnet roller is disposed in the vicinity of the image bearing member. Thus, a part of the toner which composes the magnetic brush formed on the surface of the magnet roller migrates to the surface of the image bearing member by an electrically attracting force. As a result, the latent electrostatic image is developed by the toner and the visible image is formed on the surface of the image bearing member.

The transferring step is a step of transferring the visible image onto a recording medium. It is preferable that using an intermediate transfer body, the visible image is primarily transferred onto the intermediate transfer body and subsequently the visible image is secondarily transferred onto the recording medium. The toner used at that time is typically the toner having two or more colors and it is preferable to use full color toner. Thus, it is more preferable to have a primary transferring step in which the visible image is transferred onto the intermediate transfer body to form a composite transfer image and a secondary transferring step in which the composite transfer image is transferred onto the recording medium.

The transfer can be performed by charging the image bearing member using the transferring unit. It is preferable that the transferring unit has a primary transferring unit in which the visible image is transferred onto the intermediate transfer body to form the composite transfer image and a secondary transferring unit in which the composite transfer image is transferred onto the recording medium. The intermediate transfer body can be appropriately selected from those known publicly depending on the purpose, and a transfer belt can be used.

It is preferable that the transferring unit has a transferring device which peels and charges the visible image formed on the image bearing member to the side of the recording medium. There may be one transferring unit or multiple transferring units. Specific examples of the transferring device include a corona transferring device, the transfer belt, a transfer roller, a pressure transfer roller and an adhesion transferring device. The recording medium can be appropriately selected from the recording media known publicly, and recording papers can be used.

The fixing step is a step of fixing the visible image transferred onto the recording medium using the fixing unit. Each color toner may be fixed every transfer onto the recording medium, or respective toners may be laminated and then fixed all at once. The fixing unit can be appropriately selected depending on the purpose, and heating pressurizing units known publicly can be used. The heating pressurizing units include the combination of a heating roller and a pressurizing roller and the combination of the heating roller, the pressurizing roller and an endless belt. The heating in the heating pressurizing unit is preferably to be at 80° C. to 200° C. typically. Depending on the purpose, together with or in place of the fixing unit, a light fixing device known publicly may be used.

The electricity removing step is a step of removing the electricity by applying an electricity removing bias to the image bearing member, and can be performed using the electricity removing unit. The electricity removing unit can be appropriately selected from electricity removing devices known publicly, and an electricity removing lamp can be used.

The cleaning step is a step of removing the toner left on the image bearing member, and can be performed using the cleaning unit. The cleaning unit can be appropriately selected from publicly known cleaners. A magnetic brush cleaner, an electrostatic brush cleaner, a magnetic roller cleaner, a blade cleaner, a brush cleaner and a web cleaner can be used.

The recycling step is a step of recycling the toner removed in the cleaning step in the developing unit, and can be performed using the recycling unit. The recycling unit can be appropriately selected depending on the purpose, and publicly known feeding units can be used.

The controlling step is a step of controlling respective steps, and can be performed using the controlling unit. The controlling unit can be appropriately selected depending on the purpose, and equipments such as sequencers and computers can be used.

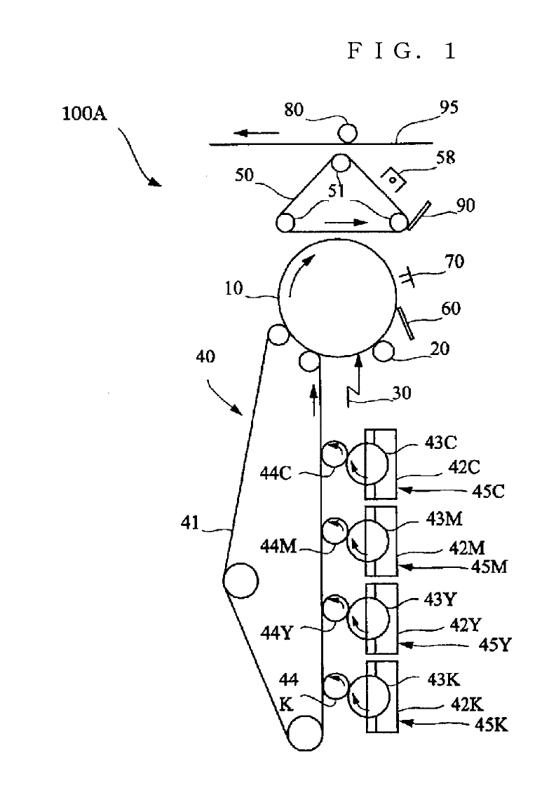

In FIG. 1, one example of the image forming apparatus used in the present invention is shown. The image forming apparatus 100A comprises a drum-shaped photoconductor 10, a charging roller 20 as the charging unit, an exposing apparatus 30 as the exposing unit, a developing apparatus 40 as the developing unit, an intermediate transfer body 50, a cleaning apparatus 60 as the cleaning unit and an electricity removing lamp 70 as the electricity removing unit.

The intermediate transfer body 80 is an endless belt, and is tightly stretched with three rollers 51 so as to move in an arrow direction. A part of three roller 51 also functions as a transfer bias roller which can apply a given transfer bias (primary transfer bias) to the intermediate transfer body 50. The cleaning apparatus 90 having a cleaning blade is disposed in the vicinity of the intermediate transfer body 50. A transferring roller 80 is oppositely disposed as the transferring unit which can apply the transfer bias to transfer (secondary transfer) the visible image (toner image) onto a recording paper 95 as the recording medium. In a surrounding area of the intermediate transfer body 50, the corona charging device 58 for imparting the charge to the toner image on the intermediate transfer body 50 is disposed in a rotation direction of the intermediate transfer body 50, between a contact section of the photoconductor 10 with the intermediate transfer body 50 and a contact section of the intermediate transfer body 50 with a transfer paper 95.

The developing apparatus is composed of a developing belt 41 and a black developing device 45K, a yellow developing device 45Y, a magenta developing device 45M and a cyan developing device 45C arranged together around the developing belt 41. The black developing device 45K comprises a developer housing section 42K, a developer supplying roller 43K and a developing roller 44K, the yellow developing device 45Y comprises a developer housing section 42Y, a developer supplying roller 43Y and a developing roller 44Y, the magenta developing device 45M comprises a developer housing section 42M, a developer supplying roller 43M and a developing roller 44M, and the cyan developing device 45C comprises a developer housing section 42C, a developer supplying roller 43C and a developing roller 44C. The developing belt 41 is the endless belt and tightly stretched with multiple belt rollers so as to move in the arrow direction, and a part thereof is contacted with the photoconductor 10.

In the image forming apparatus 100A, the charging roller 20 charges the photoconductor 10 evenly, and subsequently the photoconductor 10 is exposed using the exposing apparatus 30 to form the latent electrostatic image. Subsequently, the latent electrostatic image formed on the photoconductor 10 is developed by supplying the developer from the developing apparatus 40. Furthermore, the toner image is transferred onto the intermediate transfer body 50 (primary transfer) by voltage applied from the roller 51, and further transferred onto the recording paper 95 (secondary transfer). As a result, the transfer image is formed on the recording paper 95. The toner left on the photoconductor 10 is removed by the cleaning apparatus 60 having the cleaning blade, and the charged charge on the photoconductor is removed by the electricity removing lamp 70.

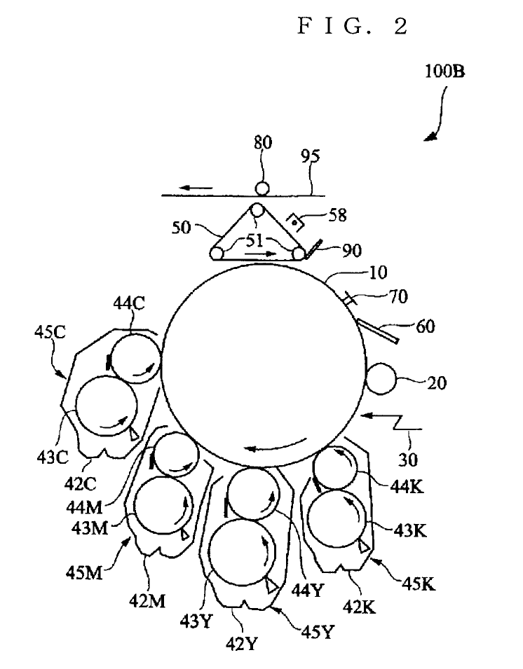

In FIG. 2, another example of the image forming apparatus used in the present invention is shown. The image forming apparatus 100B has the same constitution and exhibits the same action effects as in the image forming apparatus 100 A, except for comprising no developing belt 41 and oppositely disposing the black developing unit 45K, the yellow developing unit 45Y, the magenta developing unit 45M and the cyan developing unit 45C. In FIG. 2, those which were the same as in FIG. 1 were represented by the same signs.

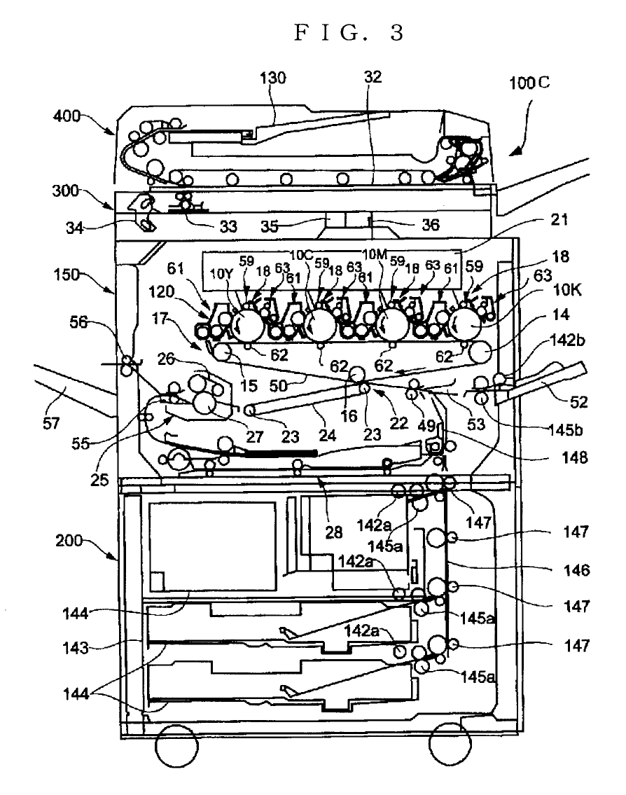

In FIG. 3, another example of the image forming apparatus used in the present invention is shown. The image forming apparatus 100C is a tandem type color image forming apparatus. The image forming apparatus 100C comprises a copy apparatus main body 150, a paper supply table 200, a scanner 300 and an automatically draft feeding apparatus 400. In the copy apparatus main body 150, the endless belt-shaped intermediate transfer body 50 is provided in a central section. And, the intermediate transfer body 50 is tightly stretched with support rollers 14, 15 and 16. An intermediate transfer body cleaning apparatus 17 to remove the toner left on the intermediate transfer body 50 is disposed in the vicinity of the support roller 15. A tandem type developing device 120 in which 4 color image forming units 18 of yellow, cyan, magenta and black have been oppositely arranged together is disposed to the intermediate transfer body 50 tightly stretched with the support rollers 14 and 15, along a feeding direction thereof. In the vicinity of the tandem type developing device 120, the exposing apparatus 21 is disposed. A secondary transferring apparatus 22 is disposed at the side of the intermediate transfer body opposite to the side at which the tandem type developing device 120 is disposed. In the secondary transferring apparatus, a secondary transfer belt 24 which is the endless belt is tightly stretched with a pair of rollers 23, and the recording paper fed on the secondary transfer belt 24 can be mutually contacted with the intermediate transfer body 50. In the vicinity of the secondary transferring apparatus 22, the fixing apparatus 25 is disposed. The fixing apparatus 25 comprises a fixing belt 26 which is the endless belt and a pressurizing roller 27 disposed by press-pushing to the fixing belt 26.

In the image forming apparatus 100C, in the vicinity of the secondary transferring apparatus 22 and the fixing apparatus 25, a sheet reversal apparatus 28 which reverses the transfer paper is disposed. This enables to form the image on both sides of the recording paper.

Subsequently, the formation of the full color image (color copy) using the tandem type developing device will be described. First, a draft is set on a draft table 130 of the automatically draft feeding apparatus 400, or alternatively the automatically draft feeding apparatus 400 is opened, the draft is set on a contact glass 32 of the scanner 300 and the automatically draft feeding apparatus 400 is closed.

When a start switch (not shown in the figure) is pushed, after feeding the draft onto the contact glass 32 when the draft has been set in the automatically draft feeding apparatus 400, or immediately when the draft has been set on the contact glass 32, the scanner is driven, and a first carriage 33 and a second carriage 34 runs. At that time, reflection light from a draft side irradiated from the first carriage is reflected at a mirror in the second carriage 34, and received by a reading sensor 36 through an imaging lens 35. By this operation, a color draft (color image) is read out to generate an image information of respective colors such as black, yellow, magenta and cyan. Image information of respective colors are transmitted to respective image forming units 18 in the tandem type developing device 120 to form the toner image of the respective colors.

The toner image on the photoconductor 10K for black, the toner image on the photoconductor 10Y for yellow, the toner image on the photoconductor 10M for magenta and the toner image on the photoconductor 10C for cyan are sequentially transferred on the intermediate transfer body 50 (primary transfer). A synthesized color image is formed by overlaying respective colored toner images on the intermediate transfer body to form the synthetic color image (colored transfer image).

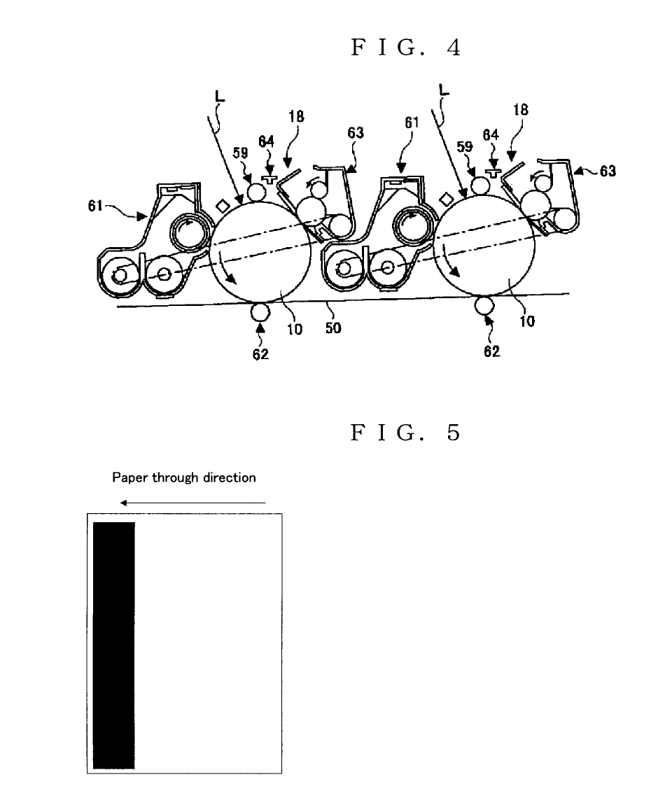

As shown in FIG. 4, each image forming unit 18 of each color in the tandem type developing device 120 comprises the photoconductor 10, a charging device 59 which evenly charges the photoconductor 10, the exposing apparatus 21 which forms the latent electrostatic image on the photoconductor 10 by exposing (L in the figure) the photoconductor 10 based on image information for each color, a developing device 61 which forms the toner image of each color on the photoconductor 10, a transfer charging device 62 which transfers the toner image of each color onto the intermediate transfer body 50, a photoconductor cleaning apparatus 63 and an electricity removing device 64.

Meanwhile, in the paper supply table 200, one of paper supply roller 142a is selectively rotated, the recording paper is turned out from one of paper supply cassettes provided in multiple stages in a paper bank 143, separated one by one by a separation roller 145a to send out to a paper supply path 146, fed by a feeding roller 147 to lead a paper supply path 148 in the copy machine main body 150, and stopped by hitting against a resist roller 49. Alternatively, the recording paper on a manual paper feeding tray is turned out by rotating a paper supply roller 142b, separated one by one to place a manual paper feeding paper supply path 53, and similarly stopped by hitting against the resist roller 49. The resist roller 49 is generally used by connecting to ground, but may be used by applying bias for removing paper powders of the sheet.

And, a color transfer image is formed on the recording paper by rotating the resist roller 49 in timing with a color transfer image formed on the intermediate transfer body 50 and sending out the recording paper between the intermediate transfer body 50 and the secondary transferring apparatus 22. The toner left on the intermediate transfer body 50 after the transfer is cleaned by the intermediate transfer body cleaning apparatus 17.

The recording paper on which the color transfer image has been formed is fed to the fixing apparatus 25 by the secondary transferring apparatus 25, and the color transfer image is fixed on the recording paper with heat and pressure. Thereafter, the recording paper is switched at a switch blade 55 to discharge by a discharging roller 56, and stacked on a paper discharge tray 57. Alternatively, the recording paper is switched at the switch blade 55, reversed by the reversing apparatus 28 to lead again to the transfer position, and the image is formed on a backside, then the paper is discharged by the discharging roller 56 and stacked on the paper discharge tray 57.

### EXAMPLES

Examples of the present invention will be described below, but the present invention is not limited to the following Examples at all. Parts in Examples mean parts by weight.

(Preparation of Non-reactive Resin 1)

In a reaction vessel equipped with a cooling tube, a stirrer and a nitrogen introducing tube, 229 parts of bisphenol A ethylene oxide 2 mol adduct, 529 parts of bisphenol A propylene oxide 3 mol adduct, 208 parts of terephthalic acid, 46 parts of adipic acid and 2 parts of dibutyl tin oxide were added, reacted at 230° C. at atmospheric pressure for 8 hours, and further reacted at reduced pressure of 10 mmHg to 15 mmHg for 3 hours. Then 44 parts of trimellitic acid anhydrate was added into the reaction vessel, and the mixture was reacted at 180° C. at atmospheric pressure for 2 hours to yield a non-reactive resin 1. The non-reactive rein 1 had a weight average molecular weight of 3,400 in GPC, an acid value of 20 mg KOH/g and a glass transition temperature of 45° C.

(Preparation of Non-reactive Resin 2)

In a reaction chamber equipped with a cooling tube, a stirrer and a nitrogen introducing tube, 229 parts of bisphenol A ethylene oxide 2 mol adduct, 529 parts of bisphenol A propylene oxide 3 mol adduct, 208 parts of terephthalic acid, 46 parts of adipic acid and 2 parts of dibutyl tin oxide were added, and reacted at 230° C. at atmospheric pressure for 7 hours. Subsequently, the mixture was reacted at reduced pressure of 10 mmHg to 15 mmHg for 4 hours. Then 44 parts of trimellitic acid anhydrate was added into the reaction chamber, and the mixture was reacted at 180° C. at atmospheric pressure for 2 hours to yield a non-reactive resin 2. The non-reactive rein 2 had the weight average molecular weight of 5,040, the glass transition temperature of 43° C. and the acid value of 25 mg KOH/g.

(Preparation of Non-reactive Resin 3)

Polyoxypropylene(2.2)-2,2-bis(4-hydroxyphenyl)propane (1225 g), 165 g of polyoxyethylene(2.2)-2,2-bis(4-hydroxyphenyl)propane, 500 g of terephthalic acid, 130 g of isododecenyl succinic acid anhydrate and 170 g of triisopropyl 1,2,4-benzenetricarboxylate were added together with an esterification catalyst in a flask. These were reacted in the same apparatus and condition as in the non-reactive resin 1 to yield a polyester resin of a non-reactive resin 3 having the weight average molecular weight of 9,200, the acid value of 28 mg KOH/g and the glass transition temperature of 44° C.

(Preparation of Non-reactive Resin 4)

In a four-necked separable flask equipped with a stirrer, a thermometer, a nitrogen introducing inlet, a falling type condenser and a cooling tube, 740 g of polyoxypropylene(2.2)-2,2-bis(4-hydroxyphenyl)propane, 300 g of polyoxyethylene(2.2)-2,2-bis(4-hydroxyphenyl)propane, 466 g of terephthalic acid, 80 g of isododecenyl succinic acid anhydrate and 114 g of triisopropyl 1,2,4-benzenetricarboxylate were added together with the esterification catalyst. The temperature was raised up to 210° C. at atmospheric pressure in an anterior half and the pressure was reduced at 210° C. in a posterior half to react the mixture by stirring under a nitrogen atmosphere. A polyester resin of a non-reactive resin 4 having the weight average molecular weight of 2,300, the acid value of 24 mg KOH/g and the glass transition temperature of 46° C. was yielded.

(Preparation of Non-reactive Resin 5)

In a reaction vessel equipped with a cooling tube, a stirrer and a nitrogen introducing tube, 229 parts of bisphenol A ethylene oxide 2 mol adduct, 529 parts of bisphenol A propylene oxide 3 mol adduct, 208 parts of terephthalic acid, 46 parts of adipic acid and 2 parts of dibutyl tin oxide were added, reacted at 230° C. at atmospheric pressure for 8 hours, and further reacted at reduced pressure of 10 mmHg to 15 mmHg for 5 hours. Then 33 parts of trimellitic acid anhydrate was added into the reaction vessel, and the mixture was reacted at 180° C. at atmospheric pressure for 2 hours to yield a non-reactive resin 5. The non-reactive rein 5 had the weight average molecular weight of 11,100, the glass transition temperature of 43° C. and the acid value of 18 mg KOH/g.

(Preparation of Non-reactive Resin 6)

In a separable flask equipped with a stirrer, a thermometer, a nitrogen introducing inlet and a cooling tube, 378.4 g of a low molecular bisphenol A type epoxy resin (number average molecular weight: about 360), 191.0 g of a glycidylated compound of a high molecular bisphenol A type propylene oxide adduct (n+m=about 2.1 in the above general formula (1)), 274.5 g of bisphenol F, 70.1 g of p-cumylphenol and 200 g of xylene were added. The temperature was raised up to 70° C. to 100° C. under the nitrogen atmosphere, 0.1839 g of lithium chloride was added, further the temperature was raised up to 160° C., xylene was removed under reduced pressure and the mixture was polymerized at 180° C. for 5 hours. A polyol resin of a non-reactive resin 6 having the weight average molecular weight of 5,200 and the glass transition temperature of 44° C. was yielded. 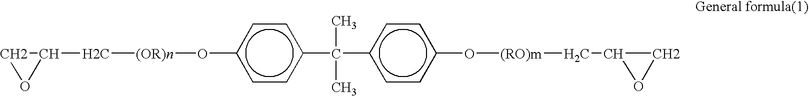
(wherein R is —CH₂—CH₂—, 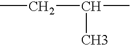
or —CH₂—CH₂—CH₂— n and m are numbers of repeat units, each is 1 or more and n+m is 2 to 6.)
(Preparation of Non-reactive Resin 7)

In a reaction vessel equipped with a cooling tube, a stirrer and a nitrogen introducing tube, 229 parts of bisphenol A ethylene oxide 2 mol adduct, 529 parts of bisphenol A propylene oxide 3 mol adduct, 258 parts of terephthalic acid and 2 parts of dibutyl tin oxide were added, reacted at 230° C. at atmospheric pressure for 8 hours, and further reacted at reduced pressure of 10 mmHg to 15 mmHg for 5 hours. Then 55 parts of trimellitic acid was added into the reaction vessel, and the mixture was reacted at 180° C. at atmospheric pressure for 3 hours to yield a non-reactive resin 7. The non-reactive rein 7 had the weight average molecular weight of 7,800, the glass transition temperature of 43° C. and the acid value of 25 mg KOH/g.

### Example 1 (Preparation of Toner 1)

Water (1200 parts), 540 parts of carbon black Printex 35 (supplied from Degussa DBP oil absorption=42 mL/100 mg, pH 9.5) and 1200 parts of the non-reactive resin 1 were mixed using Henschel mixer (supplied from Mitsui Mining Co., Ltd.). The resulting mixture was kneaded using two rolls at 150° C. for 30 minutes, then pressurized and extended to cool, and pulverized using a pulverizer (supplied from Hosokawa Micron Ltd.) to prepare a master batch 1.

In a reaction vessel equipped with a stirring bar and a thermometer, 378 parts of the non-reactive resin 1, 110 parts of carnauba wax and 947 parts of ethyl acetate were placed. With stirring, the temperature was raised up to 80° C., kept at 80° C. for 5 hours, and then cooled to 30° C. over one hour. Subsequently, in the reaction vessel, 500 parts of the master batch 1 and 500 parts of ethyl acetate were placed, and mixed for one hour to yield a raw material dissolution solution.

Subsequently, 1324 parts of the resulting raw material dissolution solution was transferred to a reaction vessel. Using Ultraviscomill (supplied from Imex) which was a bead mill, 80% by volume was filled with 0.5 mm zirconia beads. The carnauba wax was dispersed by passing three times at a liquid sending speed of 1 kg/hour and a disc peripheral speed of 6 m/second to yield a wax dispersion.

In a reaction vessel equipped with a stirring bar and a thermometer, 170 parts of isophoronediamine and 75 parts of methyl ethyl ketone were placed, and reacted at 50° C. for 5 hours to synthesize a ketimine compound. An amine value of the resulting ketimine compound was 418 mg KOH/g.

Subsequently, 1324 parts of a solution of 65% by weight non-reactive resin 1 in ethyl acetate was added to the above wax dispersion. To 200 parts of a dispersion obtained by passing once in the same way as in the above using Ultraviscomill, 2.0 parts of Clayton APA (supplied from southern Clay Products) which was the organically exchanged layered inorganic material as a charge controlling agent was added, further 5.8 parts of the ketimine compound was added, and the mixture was stirred at 7,000 rpm using T. K. Homodisper (Tokushu Kika Kogyo Co., Ltd.) for 60 minutes to yield a dispersion of toner materials (first oil phase).

In a reaction vessel equipped with a cooling tube, a stirrer and a nitrogen introducing tube, 682 parts of bisphenol A ethylene oxide 2 mol adduct, 81 parts of bisphenol A propylene oxide 2 mol adduct, 283 parts of terephthalic acid, 22 parts of trimellitic acid anhydrate and 2 parts of dibutyl tin oxide were placed, reacted at 230° C. at atmospheric pressure for 8 hours, and further reacted at reduced pressure of 10 mmHg to 15 mmHg for 5 hours to synthesize an intermediate polyester resin.

The resulting intermediate polyester resin had a number average molecular weight of 4,500, the weight average molecular weight of 20,300, the glass transition temperature of 55° C. and the acid value of 0.5 mg KOH/g, and a hydroxyl group value of 51 mg KOH/g.

Subsequently in a reaction vessel equipped with a cooling tube, a stirrer and a nitrogen introducing tube, 410 parts of the intermediate polyester resin, 89 parts of isophorone diisocyanate and 500 parts of ethyl acetate were placed, reacted at 100° C. for 5 hours to synthesize a prepolymer to yield a second oil phase. A content of free isocyanate in the resulting prepolymer was 1.53% by weight.

In a reaction vessel, 749 parts of the first oil phase and 115 parts of the second oil phase were placed and mixed using T.K. type Homomixer (supplied from Tokushu Kika Kogyo Co., Ltd.) at 5,000 rpm for one minute to yield an oil phase mixture.

In a reaction vessel equipped with a stirring bar and a thermometer, 683 parts of water, 11 parts of Eleminol RS-30 (supplied from Sanyo Chemical Industries, Ltd.), a reactive emulsifier (sodium salt of sulfate ester of ethylene oxide adduct of methacrylic acid), 83 parts of styrene, 83 parts of methacrylic acid, 110 parts of butyl acrylate and 1 part of ammonium persulfate were placed, and stirred at 400 rpm for 15 minutes to yield a liquid emulsion. The liquid emulsion was heated up to 75° C. and reacted for 5 hours. Subsequently, 30 parts of an aqueous solution of 1% by weight ammonium persulfate was added and matured at 75° C. for 5 hours to prepare a resin particle dispersion.

A volume average particle diameter of resin particles contained in the resulting rein particle dispersion was measured using a particle diameter distribution measurement apparatus, Microtrack ultrafine particle size distribution meter UPA-EX150 (supplied from Nikkiso) using a laser Doppler method, and consequently it was 105 nm. A part of a resin content in the resin particle dispersion was dried to isolate and the glass transition temperature of the resin content was measured. Consequently it was 59° C. The weight average molecular weight was measured, and consequently was 150,000.

Water (990 parts), 83 parts of the resin particle dispersion, 37 parts of an aqueous solution of 48.5% by weight sodium dodecyldiphenyl ether sulfonate, Eleminol MON-7 (supplied from Sanyo Chemical Industries, Ltd.), 135 parts of an aqueous solution of 1% by weight of a polymer dispersant, sodium carboxymethylcellulose, Serogen (supplied from Daiichi Kogyo Seiyaku Co., Ltd.) and 90 parts of ethyl acetate were mixed and stirred to yield a water-based medium.

To 1200 parts of the water-based medium, 867 parts of the oil phase mixture was added, and mixed using T.K. Homomixer at 3,000 rpm for 20 minutes to prepare a dispersion (emulsified slurry).

Subsequently, in a reaction vessel equipped with a stirring bar and a thermometer, the emulsified slurry was placed, desolvent was performed at 30° C. for 8 hours and then maturation was performed at 45° C. for 4 hours to yield a dispersed slurry.

The dispersed slurry (100 parts by weight) was filtrated under reduced pressure, then 100 parts of ion exchange water was added to a filtration cake, which was then mixed using T.K. Homomixer at 12,000 rpm for 10 minutes followed by being filtrated.

To the resulting filtration cake, 10% by weight of phosphoric acid was added to adjust pH to 3.7, which was then mixed using T.K. Homomixer at 12,000 rpm for 10 minutes followed by being filtrated.

Furthermore, to the resulting filtration cake, 300 parts of ion exchange water was added, which was then mixed using T.K. Homomixer at 12,000 rpm for 10 minutes followed by being filtrated. These manipulations were repeated twice to yield a final filtration cake.

The resulting final filtration cake was dried using a fair wind dryer at 45° C. for 48 hours and sieved using a mesh with openings of 75 μm to yield a toner base particle 1.

As externally adding agents, 1.0 part of hydrophobic silica and 0.5 parts of hydrophobic titanium oxide were added to 100 parts of the resulting toner base particles, and mixed using Henschel mixer (supplied from Mitsui Mining Co., Ltd.) to produce toner 1. Physical property values of the resulting toner 1 are shown in Table 1.

In Table 1, the weight average molecular weight MW2′ of the second resin is the weight average molecular weight of the THF soluble fraction in the second resin.

### Example 2 (Preparation of Toner 2)

Toner 2 was obtained in the same way as in the toner 1 except that the non-reactive resin 1 in the toner 1 was changed to the non-reactive resin 2.

### Example 3 (Preparation of Toner 3)

Toner 3 was obtained in the same way as in the toner 1 except that the non-reactive resin 1 in the toner 1 was changed to the non-reactive resin 3.

### Example 4 (Preparation of Toner 4)

Toner 2 was obtained in the same way as in the toner 1 except that the non-reactive resin 1 in the toner 1 was changed to the non-reactive resin 6.

### Example 5 (Preparation of Toner 5)

Toner 5 was obtained in the same way as in the toner 2 except that 2 parts of Clayton APA in the toner 2 was changed to 0.1 parts of Clayton APA.

### Example 6 (Preparation of Toner 6)

Toner 6 was obtained in the same way as in the toner 2 except that 2 parts of Clayton APA in the toner 2 was changed to 0.06 parts of Clayton APA.

### Example 7 (Preparation of Toner 7)

Toner 7 was obtained in the same way as in the toner 2 except that 2 parts of Clayton APA in the toner 2 was changed to 4 parts of Clayton APA.

### Comparative Example 1 (Preparation of Toner 8)

Toner 8 was obtained in the same way as in the toner 1 except that the non-reactive resin 1 in the toner 1 was changed to the non-reactive resin 4.

### Comparative Example 2 (Preparation of Toner 9)

Toner 9 was obtained in the same way as in the toner 8, except that the followings were changed.

To the wax dispersion, 1324 parts of the solution of 65% by weight non-reactive resin 4 in ethyl acetate was added. To 200 parts of the dispersion obtained by passing once under the same condition as the above using Ultraviscomill, 2.0 parts of Clayton APA (supplied from Southern Clay Products) as the charge controlling agent was added, and stirred using T. K. Homodisper (Tokushu Kika Kogyo Co., Ltd.) at 10,000 rpm for 60 minutes to yield a dispersion of toner materials.

This was obtained by further strengthening the dispersion and preventing re-aggregation because it was determined that the viscosity was reduced and Clayton APA was easily re-aggregated due to the low molecular weight of the non-reactive resin 4.

### Comparative Example 3 (Preparation of Toner 10)

Toner 10 was obtained in the same way as in the toner 1 except that the non-reactive resin 1 in the toner 1 was changed to the non-reactive resin 5.

### Comparative Example 4 (Preparation of Toner 11)

Toner 11 was obtained in the same way as in the toner 2 except that 2.0 parts of Clayton APA in the toner 2 was changed to an non-exchanged layered inorganic material.

### Comparative Example 5 (Preparation of Toner 12)

| | | |
|---|---|---|
| Non-reactive resin 7 | 85 | parts |
| Master batch 1 | 15 | parts |
| Clayton APA | 1 | part |

The above materials were stirred and mixed thoroughly using Henschel mixer, subsequently kneaded using two rolls whose surface had been heated to 100° C., pressurized and extended to cool at 5° C./minute, pulverized and then pulverized/classified using I-2 type mill (supplied from Nippon Pneumatic MFG. Co., Ltd.) and DS classifier (supplied from Nippon Pneumatic MFG. Co., Ltd.) to yield toner base particles 6 whose weight average particle diameter of 6.2 μm.

As externally adding agents, 1.0 part of hydrophobic silica and 0.5 parts of hydrophobic titanium oxide were added to 100 parts of the resulting toner base particles, and mixed using Henschel mixer (supplied from Mitsui Mining Co., Ltd.) to produce toner 12.

### Example 8 (Preparation of toner 13)

Preparation of colorant dispersion (1)

| | | |
|---|---|---|
| Carbon black (supplied from Degussa: Printex 35) | 125 | parts |
| Ajisper PB821 (supplied from Ajinomoto Fine Techno) | 18.8 | parts |
| Ethyl acetate (supplied from Wako Pure Chemical | 356.2 | parts |
| Industries Ltd., special grade) | | |

The above materials were dissolved and dispersed using Ultraviscomill (supplied from Imex) to prepare a colorant dispersion 1 dispersing a colorant (black pigment).

Preparation of releasing agent dispersion (1) (wax component A)

| | |
|---|---|
| Carnauba wax (melting point: 83° C., acid value: | 30 parts |
| 8 mg KOH/g, saponification degree: 80 mg KOH/g) | |
| Ethyl acetate (supplied from Wako Pure Chemical Industries | 270 parts |
| Ltd., special grade) | |

The above materials were wetly pulverized using Ultraviscomill (supplied from Imex) to prepare a releasing agent dispersion (1).

Preparation of layered inorganic material exchanged with organic cation (shape altering agent dispersion A)

| | |
|---|---|
| Clayton APA (supplied from Southern Clay products) | 30 parts |
| Ethyl acetate (supplied from Wako Pure Chemical Industries | 270 parts |
| Ltd., special grade) | |

The above materials were wetly pulverized using Ultraviscomill (supplied from Imex) to prepare a shape altering agent dispersion A.

| | | |
|---|---|---|
| Polyester: polyester resin composed of bisphenol A | 250 | parts |
| propylene oxide adduct, bisphenol A ethylene oxide | | |
| adduct and terephthalic acid derivative | | |
| (Mw: 7,800, Mn: 2,900, acid value: | | |
| 15 mg KOH/g, hydroxyl | | |
| group value: 27 mg KOH/g, Tg 55° C., | | |
| softening point 112° C.) | | |
| Styrene acryl (Mw: 100,000, Mn: 20,000, Tg: 60° C. | 100 | parts |
| softening point 130° C.) | | |
| Colorant dispersion (1) | 237 | parts |
| Releasing agent dispersion (1) | 72 | parts |
| Shape altering agent dispersion A | 304 | parts |
| Hydrophobic silicon oxide fine particle (supplied from | 17.8 | parts |
| Aerosil, R972) | | |

The above materials were mixed and thoroughly stirred until being homogenous (this solution was made a solution A).

Meanwhile, 100 parts of a calcium carbonate dispersion obtained by dispersing 40 parts of calcium carbonate in 60 parts of water, 200 parts of an aqueous solution of 1% Serogen (supplied from Daiichi Kogyo Seiyaku Co., Ltd.) and 157 parts of water were stirred for 3 minutes using T.K. Homodisper F model (supplied from Primix) (this solution was made a solution B). A mixed solution obtained by stirring 345 parts of the solution B and 250 parts of the solution A at 10,000 rpm for 2 minutes using T.K. Homodisper F model (supplied from Primix) was suspended, and the solvent was removed by stirring using a propeller type stirrer at room temperature and atmospheric pressure. Subsequently, hydrochloric acid was added to remove calcium carbonate, and then the mixture was washed with water, dried and classified to yield toner 13. The average particle diameter of the toner 13 was 6.2 μm.

### Example 9 (Preparation of Toner 14)

In a reaction vessel equipped with a stirring bar and a thermometer, 378 parts of the non-reactive resin 3, 110 parts of carnauba wax and 947 parts of ethyl acetate were placed. With stirring, the temperature was raised up to 80° C. and kept at 80° C. for 5 hours and cooled to 30° C. over one hour. Subsequently, in the reaction vessel, 500 parts of the master batch 1 and 500 parts of ethyl acetate were placed, and mixed for one hour to yield a raw material dissolution solution.

Subsequently, 1324 parts of the resulting raw material dissolution solution was transferred to a reaction vessel. Using Ultraviscomill (supplied from Imex) which was a bead mill, 80% by volume was filled with 0.5 mm zirconia beads. The carnauba wax was dispersed by passing three times at a liquid sending speed of 1 kg/hour and a disc peripheral speed of 6 m/second to yield a wax dispersion.

Subsequently, 1324 parts of a solution of 65% by weight non-reactive resin 3 in ethyl acetate was added to the wax dispersion. To 200 parts of a dispersion obtained by passing once in the same way as in the above using Ultraviscomill, 2.0 parts of Clayton APA (supplied from southern Clay Products) which was the organically exchanged layered inorganic material as a charge controlling agent was added, further 5.8 parts of the ketimine compound was added, and the mixture was stirred at 7,000 rpm using T. K. Homodisper (Tokushu Kika Kogyo Co., Ltd.) for 60 minutes to yield a dispersion of toner materials (first oil phase).

In a reaction vessel equipped with a cooling tube, a stirrer and a nitrogen introducing tube, 682 parts of bisphenol A ethylene oxide 2 mol adduct, 81 parts of bisphenol A propylene oxide 3 mol adduct, 566 parts of terephthalic acid, 22 parts of trimellitic acid anhydrate and 2 parts of dibutyl tin oxide were placed, reacted at 230° C. at atmospheric pressure for 8 hours, and further reacted at reduced pressure of 10 mmHg to 15 mmHg for 5 hours to synthesize an intermediate polyester resin.

The resulting intermediate polyester resin had a number average molecular weight of 2,100, the weight average molecular weight of 13,000, the glass transition temperature of 51° C. and the acid value of 0.5 mg KOH/g, and a hydroxyl group value of 50 mg KOH/g.

Subsequently in a reaction vessel equipped with a cooling tube, a stirrer and a nitrogen introducing tube, 410 parts of the intermediate polyester resin, 89 parts of isophorone diisocyanate and 500 parts of ethyl acetate were placed, reacted at 100° C. for 5 hours to synthesize a prepolymer to yield a second oil phase. A content of free isocyanate in the resulting prepolymer was 1.53% by weight.

In a reaction vessel equipped with a stirring bar and a thermometer, 170 parts of isophoronediamine and 75 parts of methyl ethyl ketone were placed, and reacted at 50° C. for 5 hours to synthesize a ketimine compound. An amine value of the resulting ketimine compound was 418 mg KOH/g.

In a reaction vessel, 749 parts of the first oil phase, 115 parts of the second oil phase and 2.9 parts of the ketimine compound were placed and mixed using T.K. type Homomixer (supplied from Tokushu Kika Kogyo Co., Ltd.) at 5,000 rpm for one minute to yield an oil phase mixture.

In a reaction vessel equipped with a stirring bar and a thermometer, 683 parts of water, 11 parts of Eleminol RS-30 (supplied from Sanyo Chemical Industries, Ltd.), a reactive emulsifier (sodium salt of sulfate ester of ethylene oxide adduct of methacrylic acid), 83 parts of styrene, 83 parts of methacrylic acid, 110 parts of butyl acrylate and 1 part of ammonium persulfate were placed, and stirred at 400 rpm for 15 minutes to yield a liquid emulsion. The liquid emulsion was heated up to 75° C. and reacted for 5 hours. Subsequently, 30 parts of an aqueous solution of 1% by weight ammonium persulfate was added and matured at 75° C. to prepare a resin particle dispersion.

A volume average particle diameter of resin particles contained in the resulting rein particle dispersion was measured using a particle diameter distribution measurement apparatus, Microtrack ultrafine particle size distributor UPA-EX150 (supplied from Nikkiso) using a laser Doppler method, and consequently it was 105 nm. A part of a resin content in the resin particle dispersion was dried to isolate and the glass transition temperature of the resin content was measured. Consequently it was 59° C. The weight average molecular weight was measured, and consequently was 150,000.

Water (990 parts), 83 parts of the resin particle dispersion, 37 parts of an aqueous solution of 48.5% by weight sodium dodecyldiphenyl ether sulfonate, Eleminol MON-7 (supplied from Sanyo Chemical Industries, Ltd.), 135 parts of an aqueous solution of 1% by weight of a polymer dispersant, sodium carboxymethylcellulose, Serogen (supplied from Daiichi Kogyo Seiyaku Co., Ltd.) and 90 parts of ethyl acetate were mixed and stirred to yield a water-based medium. To 1200 parts of the water-based medium, 867 parts of the oil phase mixture was added, and mixed using T.K. Homomixer at 3,000 rpm for 20 minutes to prepare a dispersion (emulsified slurry).

Subsequently, in a reaction vessel equipped with a stirring bar and a thermometer, the emulsified slurry was placed, desolvent was performed at 30° C. for 8 hours and then maturation was performed at 45° C. for 4 hours to yield a dispersed slurry.

The dispersed slurry (100 parts by weight) was filtrated under reduced pressure, then 100 parts of ion exchange water was added to a filtration cake, which was then mixed using T.K. Homomixer at 12,000 rpm for 10 minutes followed by being filtrated.

To the resulting filtration cake, 10% by weight of phosphoric acid was added to adjust pH to 3.7, which was then mixed using T.K. Homomixer at 12,000 rpm for 10 minutes followed by being filtrated.

Furthermore, to the resulting filtration cake, 300 parts of ion exchange water was added, which was then mixed using T.K. Homomixer at 12,000 rpm for 10 minutes followed by being filtrated. These manipulations were repeated twice to yield a final filtration cake.

The resulting final filtration cake was dried using a fair wind dryer at 45° C. for 48 hours and sieved using the mesh with openings of 75 μm to yield a toner base particle 14.

As the externally adding agents, 1.0 part of hydrophobic silica and 0.5 parts of hydrophobic titanium oxide were added to 100 parts of the resulting toner base particles, and mixed using Henschel mixer (supplied from Mitsui Mining Co., Ltd.) to produce toner 14.

### Example 10 (Preparation of Toner 15)

Toner 15 was obtained in the same way as in the toner 14 except that the non-reactive resin 3 in the toner 14 was changed to the non-reactive resin 1.

### Example 11 (Preparation of Toner 16)

Water (1200 parts), 540 parts of carbon black Printex 35 (supplied from Degussa DBP oil absorption=42 mL/100 mg, pH 9.5) and 1200 parts of the non-reactive resin 2 were mixed using Henschel mixer (supplied from Mitsui Mining Co., Ltd.). The resulting mixture was kneaded using two rolls at 150° C. for 30 minutes, then pressurized and extended to cool, and pulverized using a pulverizer (supplied from Hosokawa Micron Ltd.) to prepare a master batch 2.

In a reaction vessel equipped with a stirring bar and a thermometer, 378 parts of the non-reactive resin 2, 110 parts of carnauba wax and 947 parts of ethyl acetate were placed. With stirring, the temperature was raised up to 80° C., kept at 80° C. for 5 hours, and then cooled to 30° C. over one hour. Subsequently, in the reaction vessel, 500 parts of the master batch 2 and 500 parts of ethyl acetate were placed, and mixed for one hour to yield a raw material dissolution solution.

Subsequently, 1324 parts of the resulting raw material dissolution solution was transferred to a reaction vessel. Using Ultraviscomill (supplied from Imex) which was a bead mill, 80% by volume was filled with 0.5 mm zirconia beads. The carnauba wax was dispersed by passing three times at a liquid sending speed of 1 kg/hour and a disc peripheral speed of 6 m/second to yield a wax dispersion.

In a reaction vessel equipped with a cooling tube, a stirrer and a nitrogen introducing tube, 682 parts of bisphenol A ethylene oxide 2 mol adduct, 81 parts of bisphenol A propylene oxide 3 mol adduct, 283 parts of terephthalic acid, 22 parts of trimellitic acid anhydrate and 2 parts of dibutyl tin oxide were placed, reacted at 230° C. at atmospheric pressure for 8 hours, and further reacted at reduced pressure of 10 mmHg to 15 mmHg for 5 hours to synthesize an intermediate polyester resin.

The resulting intermediate polyester resin had a number average molecular weight of 4,500, the weight average molecular weight of 20,300, the glass transition temperature of 55° C. and the acid value of 0.5 mg KOH/g, and a hydroxyl group value of 51 mg KOH/g.

Subsequently in a reaction vessel equipped with a cooling tube, a stirrer and a nitrogen introducing tube, 410 parts of the intermediate polyester resin, 89 parts of isophorone diisocyanate and 500 parts of ethyl acetate were placed, reacted at 100° C. for 5 hours to synthesize a prepolymer. A content of free isocyanate in the resulting prepolymer was 1.53% by weight.

In a reaction vessel equipped with a stirring bar and a thermometer, 170 parts of isophoronediamine and 75 parts of methyl ethyl ketone were placed, and reacted at 50° C. for 5 hours to synthesize a ketimine compound. An amine value of the resulting ketimine compound was 418 mg KOH/g.

Subsequently, 1324 parts of a solution of 65% by weight non-reactive resin 2 in ethyl acetate was added to the above wax dispersion. To 200 parts of a dispersion obtained by passing once in the same way as in the above using Ultraviscomill, 2.0 parts of Clayton APA (supplied from southern Clay Products) which was the organically exchanged layered inorganic material as the charge controlling agent was added, further 5.8 parts of the ketimine compound and 553 parts of the prepolymer were added, and the mixture was stirred at 7,000 rpm using T. K. Homodisper (Tokushu Kika Kogyo Co., Ltd.) for 60 minutes to yield an oil phase mixture of toner materials

In a reaction vessel equipped with a stirring bar and a thermometer, 683 parts of water, 11 parts of Eleminol RS-30 (supplied from Sanyo Chemical Industries, Ltd.), a reactive emulsifier (sodium salt of sulfate ester of ethylene oxide adduct of methacrylic acid), 83 parts of styrene, 83 parts of methacrylic acid, 110 parts of butyl acrylate and 1 part of ammonium persulfate were placed, and stirred at 400 rpm for 15 minutes to yield a liquid emulsion. The liquid emulsion was heated up to 75° C. and reacted for 5 hours. Subsequently, 30 parts of an aqueous solution of 1% by weight ammonium persulfate was added and matured at 75° C. for 5 hours to prepare a resin particle dispersion.

A volume average particle diameter of resin particles contained in the resulting rein particle dispersion was measured using a particle diameter distribution measurement apparatus, Microtrack ultrafine particle size distributor UPA-EX150 (supplied from Nikkiso) using the laser Doppler method, and consequently it was 105 nm. A part of a resin content in the resin particle dispersion was dried to isolate and the glass transition temperature of the resin content was measured. Consequently it was 59° C. The weight average molecular weight was measured, and consequently was 150,000.

Water (990 parts), 83 parts of the resin particle dispersion, 37 parts of an aqueous solution of 48.5% by weight sodium dodecyldiphenyl ether sulfonate, Eleminol MON-7 (supplied from Sanyo Chemical Industries, Ltd.), 135 parts of an aqueous solution of 1% by weight of a polymer dispersant, sodium carboxymethylcellulose, Serogen (supplied from Daiichi Kogyo Seiyaku Co., Ltd.) and 90 parts of ethyl acetate were mixed and stirred to yield a water-based medium.

To 1200 parts of the water-based medium, 867 parts of the oil phase mixture was added, and mixed using T.K. Homomixer at 3,000 rpm for 20 minutes to prepare a dispersion (emulsified slurry).

Subsequently, in a reaction vessel equipped with a stirring bar and a thermometer, the emulsified slurry was placed, the desolvent was performed at 30° C. for 8 hours and then the maturation was performed at 45° C. for 4 hours to yield a dispersed slurry.

The dispersed slurry (100 parts by weight) was filtrated under reduced pressure, then 100 parts of ion exchange water was added to a filtration cake, which was then mixed using T.K. Homomixer at 12,000 rpm for 10 minutes followed by being filtrated.

To the resulting filtration cake, 10% by weight of phosphoric acid was added to adjust pH to 3.7, which was then mixed using T.K. Homomixer at 12,000 rpm for 10 minutes followed by being filtrated.

Furthermore, to the resulting filtration cake, 300 parts of ion exchange water was added, which was then mixed using T.K. Homomixer at 12,000 rpm for 10 minutes followed by being filtrated. These manipulations were repeated twice to yield a final filtration cake.

The resulting final filtration cake was dried using a fair wind dryer at 45° C. for 48 hours and sieved using the mesh with openings of 75 μm to yield a toner base particle 16.

As externally adding agents, 1.0 part of hydrophobic silica and 0.5 parts of hydrophobic titanium oxide were added to 100 parts of the resulting toner base particles, and mixed using Henschel mixer (supplied from Mitsui Mining Co., Ltd.) to produce toner 16.

### Example 12 (Preparation of Toner 17)

Toner 17 was obtained in the same way as in the toner 2 except that an amount of the ketimine compound in Example 2 was changed from 5.8 parts to 9.7 parts.

The resulting toners were evaluated as follows, and the results are shown in Table 1.

Evaluations

(Charge Property)

The carrier (9 g) and 1 g of the toner were placed in a cylindrical stainless pot with φ of 30 mm and a width of 30 mm, and stirred.

A stirring time periods were made 60 seconds, 10 minutes and 24 hours, and the charge property for these 3 time periods was identified.

The charge amount of the stirred developer (1 g) after stirring was determined using a blow off apparatus supplied from Toshiba Chemical Corporation.

Furthermore, after measuring the charge amount, the blown carrier was collected again, the toner was newly added, stirred for 10 minutes, and then the charge amount was measured again.

Here, the charge amount after stirring for 60 seconds is an indicator of a rising edge of the charge property, and is desirably nearly equal to the charge amount after stirring for 10 minutes.

It is necessary that the charge property is flat after stirring for 10 minutes and one day. If the charge amount after stirring for one day is reduced, effects such as spent and leakage of the charge property are conceived.

Measuring again the charge property after the blow and identifying the charge property after stirring for 10 minutes (compared with new charge after 10 minutes) are for identify that the charging capacity is not reduced when the new toner added, due to adhesion and spent of the toner base particles on the carrier surface. If this charge is reduced compared with the new combination, it can be determined that there is the effect due to the spent and the toner is not durable for long term use. In the present invention, the toner showing the 30% or more variation of the charge property compared with that after newly stirring for 10 minutes was determined as NG.

(Fixing Property)

A fixing machine was remodeled using Ricoh IPSIO color 8100, and adjusted so that 1.0±0.1 mg/cm² of the toner was developed on a solid image. The temperature at which on offset occurred on type 6200 papers supplied from Ricoh was made a fixing upper limit temperature. A fixing lower limit temperature was measured using type 600/90W papers supplied from Ricoh. A roll temperature at which a residual rate of the image density after rubbing the resulting fixed image with a pad is 70% or more was rendered the fixing lower limit temperature.

For the fixing lower limit temperature, in the case of 150° C. or above, it was determined that there was no safety margin and the toner could not be used (defined as D), in the case of 140° C. or below, it was determined that there was the safety margin (defined as B), and the case of 140° C. to 150° C. was defined as C. (Circularity and % by Number of Particles with a Diameter of 2 μm or Less)

In the present invention, the ultrafine powder toner was measured using a flow type particle image analyzer (FPIA-2100 supplied from Sysmex), and analyzed using analysis software (FPIA-2100 Data Processing Program for FPIA version 00-10). Specifically, 0.1 mL to 0.5 mL of 10% by weight of the surfactant (alkylbenzene sulfonate salt, Neogen SC-A supplied from Daiichi Kogyo Seiyaku Co., Ltd.) was added to a 100 mL beaker made from glass, 0.1 g to 0.5 g of each toner was added thereto, they were mixed using a microspatula, and then 80 mL of ion exchange water was added. The resulting dispersion was treated with an ultrasonic dispersing machine (supplied from Honda Electronics Co., Ltd.) for 3 minutes. The shape and distribution of the toner in the above dispersion were measured using the above FPIA-2100 until obtaining a concentration of 5,000 particles/μL to 15,000 particles/μL. In this measurement method, it is important in terms of measurement reproducibility of the circularity that the dispersion concentration is 5,000 particles/μL to 15,000 particles/μL. In order to obtain the above dispersion concentration, it is necessary to change the above condition of the dispersion, i.e., the amounts of the surfactant and the toner to be added. The amount of the surfactant required varies depending on the hydrophobicity of the toner as is the case with the measurement of the toner particle diameter. When the larger amount is added, noise due to bubbles occurs. When the smaller amount is added, the dispersion is insufficient because the surfactant can not wet the toner sufficiently. The amount of the toner to be added varies depending on the particle diameter. When the particle diameter is small, the small amount of the toner is required, whereas when it is large, the large amount is necessary. In the case of the toner particle diameters of 3 μm to 7 μm, by adding 0.1 g to 0.5 g of the toner, it becomes possible to adjust the dispersion concentration to 5,000 particles/μL to 15,000 particles/μL.

(Cleaning Evaluation)

Using the resulting toner, the amount (g) of scrape through the cleaning blade was measured as follows, and the cleaning ability was evaluated.

Cleaning Ability Evaluation

1. All of the toner and equipments used for the evaluation are left stand in a room at 25° C. and 50%.

2. All of the toner in Imagio neo C600 commercially available product PCU is removed and only the carrier is left in the developing apparatus.

3. in the developing apparatus in which only the carrier has been placed, 28 g of the toner which is a sample is added to make 400 g of the developer with a toner concentration of 7%.

4. The developing apparatus is loaded to Imagio neo C600 main body, and only the developing apparatus is driven free at a developing sleeve line speed of 300 mm/s for 5 minutes.

5. Both the developing sleeve and the photoconductor are rotated at 300 mm/s, and a charge potential and a developing bias were adjusted so that the toner on the photoconductor was 0.6±0.05 mg/cm2.

6. AS the cleaning blade, one cleaning blade mounted on Imagio neo C600 commercially available product PCU was used. its elastic modulus was 70%, its thickness was 2 mm, and a contact angle against the image bearing member in counter was 20°.

7. A transfer current was adjusted so that a transfer rate was 96±2% under the above developing condition.

8. A fibrous tape was attached before the charging roller so that the toner (toner which scraped trough the cleaning blade) after the cleaning step could be captured.

9. Using the above set values, 1,000 sheets of a chart (FIG. 5) on which a zone of 4 cm in a paper feeding direction and 25 cm in a paper feeding width direction had been written were output.

10. The weight of the toner adhered to the tape attached in 8, and the amount of scrape through the cleaning blade was evaluated. In the cases where the toner amount of scrape through was less than 0.15 g, less than 0.25 g and 0.25 g or more were defined as B, C and D, respectively.

TABLE 1

| | | | | | | | Layered inorganic* | |
|---|---|---|---|---|---|---|---|---|
| | | | | | | | | % by |
| | | | | | | | | weight |
| | | First resin | | | Second resin | | | added |
| | | | Insoluble | | | Mw2′/ | | in |
| | | Type | fraction | Mw1 | Mw2′ | Mw1 | Type | toner % |
| Example 1 | Toner 1 | Polyester | None | 3400 | 20300 | 6.0 | Clayton | 1 |
| | | | | | | | APA | |
| Example 2 | Toner 2 | Polyester | None | 5040 | 20300 | 4.0 | Clayton | 1 |
| | | | | | | | APA | |
| Example 3 | Toner 3 | Polyester | None | 9200 | 20300 | 2.2 | Clayton | 1 |
| | | | | | | | APA | |
| Example 4 | Toner 4 | Polyol | None | 5200 | 20300 | 3.9 | Clayton | 1 |
| | | | | | | | APA | |
| Example 5 | Toner 5 | Polyester | None | 5040 | 20300 | 4.0 | Clayton | 0.05 |
| | | | | | | | APA | |
| Example 6 | Toner 6 | Polyester | None | 5040 | 20300 | 4.0 | Clayton | 0.03 |
| | | | | | | | APA | |
| Example 7 | Toner 7 | Polyester | None | 5040 | 20300 | 4.0 | Clayton | 2 |
| | | | | | | | APA | |
| Example 8 | Toner 13 | Polyester | None | 7800 | 100000 | 12.8 | Clayton | 1 |
| | | | | | | | APA | |
| Example 9 | Toner 14 | Polyester | None | 9200 | 13000 | 1.4 | Clayton | 1 |
| | | | | | | | APA | |
| Example 10 | Toner 15 | Polyester | None | 3400 | 13000 | 3.8 | Clayton | 1 |
| | | | | | | | APA | |
| Example 11 | Toner 16 | Polyester | None | 5040 | 20300 | 4.0 | Clayton | 1 |
| | | | | | | | APA | |
| Example 12 | Toner 17 | Polyester | None | 5040 | 20300 | 4.0 | Clayton | 1 |
| | | | | | | | APA | |
| Comparative | Toner 8 | Polyester | None | 2300 | 20300 | 8.8 | Clayton | 1 |
| Example 1 | | | | | | | APA | |
| Comparative | Toner 9 | Polyester | None | 2300 | 20300 | 8.8 | Clayton | 1 |
| Example 2 | | | | | | | APA | |
| Comparative | Toner 10 | Polyester | None | 11000 | 20333 | 1.8 | Clayton | 1 |
| Example 3 | | | | | | | APA | |
| Comparative | Toner 11 | Polyester | None | 5040 | 20300 | 4.0 | Non- | 1 |
| Example 4 | | | | | | | exchanged | |
| Comparative | Toner 12 | Polyester | None | 7800 | 20300 | 2.2 | Clayton | 1 |
| Example 5 | | | | | | | APA | |

| | | | Physical property | | | | | |
|---|---|---|---|---|---|---|---|---|
| | | | | | % by | | | |
| | | | | | number of | | | |
| | | Homodisper | | | particles | | Evaluation | |
| | | Dispersion | | | of 2 μm or | Tg | Charge | Charge |
| | Mixed | (rpm) | Dv | Dv/Dn | less | (° C.) | 60 sec** | 10 min** |
| Example 1 | Separate | 7000 | 5.1 | 1.15 | 2 | 49 | −30.3 | −32.1 |
| Example 2 | Separate | 7000 | 5.6 | 1.15 | 3 | 51 | −32.2 | −32.9 |
| Example 3 | Separate | 7000 | 5.3 | 1.16 | 4 | 52 | −28.1 | −29.3 |
| Example 4 | Separate | 7000 | 5.5 | 1.2 | 6 | 48 | −18.9 | −23.1 |
| Example 5 | Separate | 7000 | 5.8 | 1.18 | 5 | 50 | −15.2 | −20.5 |
| Example 6 | Separate | 7000 | 5.3 | 1.17 | 3 | 51 | −6.5 | −12.5 |
| Example 7 | Separate | 7000 | 5.4 | 1.2 | 1 | 50 | −35.1 | −33.9 |
| Example 8 | Simul. | 7000 | 6.2 | 1.21 | 5 | 49 | −22.1 | −27.3 |
| Example 9 | Separate | 7000 | 5.1 | 1.2 | 8 | 50 | −25.3 | −28.1 |
| Example 10 | Separate | 7000 | 5.9 | 1.3 | 5 | 49 | −28.5 | −27.3 |
| Example 11 | Simul. | 7000 | 5.3 | 1.23 | 7 | 50 | −19.5 | −19.3 |
| Example 12 | Separate | 7000 | 4.9 | 1.23 | 15 | 50 | −24.1 | −25.3 |
| Comparative | Separate | 7000 | 5.3 | 1.22 | 5 | 51 | −27.5 | −28.3 |
| Example 1 | | | | | | | | |
| Comparative | Separate | 12000 | 5.1 | 1.19 | 7 | 52 | −28.3 | −29.1 |
| Example 2 | | | | | | | | |
| Comparative | Separate | 7000 | 5.8 | 1.15 | 6 | 50 | −11.3 | −19.8 |
| Example 3 | | | | | | | | |
| Comparative | Separate | 7000 | 5.9 | 1.25 | 4 | 51 | 0.1 | −3.5 |
| Example 4 | | | | | | | | |

| | | | | | | | |
|---|---|---|---|---|---|---|---|
| Comparative | Pulverized toner | 6.2 | 1.24 | 8 | 50 | −8.3 | −15.3 |
| Example 5 | | | | | | | |

| | Evaluation | | | | | |
|---|---|---|---|---|---|---|
| | | | fixing | | | |
| | Charge | Charge | lower | | | Total |
| | one day** | new toner*** | limit | Circularity | Cleaning | evaluation |
| Example 1 | −30.5 | −30.2 | B | 0.960 | B | A |
| Example 2 | −33.1 | −32.4 | B | 0.951 | B | A |
| Example 3 | −28.2 | −28.1 | B | 0.968 | B | A |
| Example 4 | −23.3 | −22.9 | C | 0.956 | B | B |
| Example 5 | −21.3 | −20.3 | B | 0.965 | B | A |
| Example 6 | −13.1 | −12.3 | B | 0.971 | C | B |
| Example 7 | −33.1 | −33.3 | C | 0.942 | B | B |
| Example 8 | −26.9 | −20.8 | C | 0.970 | C | B |
| Example 9 | −−25.8 | −28.1 | C | 0.968 | B | B |
| Example 10 | −27.1 | −27.7 | B | 0.965 | B | A |
| Example 11 | −19.1 | −19.2 | C | 0.963 | B | B |
| Example 12 | −28.1 | −21.2 | C | 0.960 | B | B |
| Comparative | −23.5 | −15.3 | B | 0.982 | D | D |
| Example 1 | | | | | | |
| Comparative | −−24.1 | −18.1 | B | 0.974 | C | D |
| Example 2 | | | | | | |
| Comparative | −19.3 | −19.5 | B | 0.980 | D | D |
| Example 3 | | | | | | |
| Comparative | −1.8 | −3.1 | B | 0.987 | D | D |
| Example 4 | | | | | | |
| Comparative | −10.3 | −5.3 | B | 0.930 | B | D |
| Example 5 | | | | | | |

*layered inorganic material
**Charge after stirring 60 seconds, 10 minutes or one day.
***Charge after replacing with new toner.

What is claimed is:

1. A toner, comprising:
a plurality of resins,
a colorant, and
a layered inorganic material,
wherein a first resin in the plurality of resins has a weight average molecular weight of 3,000 to 10,000 in a molecular weight distribution determined by gel permeation chromatography (GPC); the layered inorganic material is a layered inorganic material in which at least a part of ions have been exchanged with organic ions; and the toner is granulated by dispersing and/or emulsifying an oil phase containing at least any one of a toner composition and a toner composition precursor in a water-based medium.

2. The toner according to claim 1, wherein said organic ions are organic cations.

3. The toner according to claim 1 , wherein said first resin is a polyester resin.

4. The toner according to claim 3, wherein said polyester resin is an unmodified polyester resin.

5. The toner according to claim 1, wherein said first resin has no fraction which is insoluble in tetrahydrofuran (THF).

6. The toner according to claim 1, wherein a second resin in said a plurality of resins has the weight average molecular weight Mw2 which is larger than the weight average molecular weight Mw1 of the first resin.

7. The toner according to claim 6, wherein Mw2/Mw1≧1.5.

8. The toner according to claim 6, wherein said second resin comprises a crosslinking type resin.

9. The toner according to claim 8, wherein said crosslinking type resin is formed from a modified polyester resin.

10. The toner according to claim 8, wherein said crosslinking type resin is formed from a modified polyester having a site capable of reacting with an active hydrogen group and a compound having the active hydrogen group.

11. The toner according to claim 1, wherein said oil phase is formed by separately preparing a first oil phase comprising at least the first resin and a second oil phase comprising the precursor which becomes at least the second resin, comprising said exchanged layered inorganic material in one of the first or second oil phases and mixing them.

12. The toner according to claim 11, wherein the oil phase comprising said exchanged layered inorganic material is the first oil phase.

13. The toner according to claim 1, wherein a weight ratio of said exchanged layered inorganic material relative to said toner composition and/or toner composition precursor is 0.05% by weight to 2.0% by weight.

14. The toner according to claim 1, wherein in a distribution of said exchanged layered inorganic material in the toner, its existence amount in a region up to 5 μm from a toner surface is larger than an existence amount of a composition ratio of the combined toner.

15. The toner according to claim 1, wherein a weight ratio of the second resin to the first resin in said a plurality of resins is 5/95 to 30/70.

16. The toner according to claim 1, wherein in said oil phase, at least the toner composition and/or the toner composition precursor has been dissolved or dispersed in the solvent.

17. The toner according to claim 16, wherein said solvent contains an organic solvent and wherein said organic solvent is removed upon granulation.

18. The toner according to claim 1, wherein an average circularity of said toner is 0.930 to 0.970.

19. A method for producing toner prepared by dispersing and/or emulsifying an oil phase comprising at least a toner composition and/or a toner composition precursor in a water-based medium to granulate, wherein said oil phase contains at least a first resin, a precursor of a second resin or the second resin and a layered inorganic material in which at least a part of ions in the layered inorganic material has been exchanged with organic ions, and wherein said toner has at least a plurality of resins, a colorant and the layered inorganic material in which at least a part of ions in the layered inorganic material has been exchanged with organic ions, and wherein said first resin has a weight average molecular weight of 3,000 to 10,000 in a molecular weight distribution obtained by gel permeation chromatography (GPC).

20. An image forming apparatus comprising an image bearing member, a charging apparatus, an exposing apparatus, a developing apparatus, a transferring apparatus, and a fixing apparatus, wherein the image bearing member bears a latent image, the charging apparatus has a charging member which evenly charges an image bearing member surface, the exposing apparatus writes a latent electrostatic image on the surface of the charged image bearing member, a developing apparatus visualizes the latent electrostatic image formed on the image bearing member surface with toner on a developer bearing member, the transferring apparatus transfers a toner image visualized on the image bearing member onto a recording medium directly or through an intermediate transfer body, the fixing apparatus fixes the toner image on the recording medium with heat and/or pressure,
wherein the image forming apparatus uses the toner comprising a plurality of resins,a colorant, and a layered inorganic material, wherein a first resin in the plurality of resins has a weight average molecular weight of 3,000 to 10,000 in a molecular weight distribution determined by gel permeation chromatography (GPC);
the layered inorganic material is a layered inorganic material in which at least a part of ions have been exchanged with organic ions; and the toner is granulated by dispersing and/or emulsifying an oil phase containing at least any one of a toner composition and a toner composition precursor in a water-based medium.
